(19) United States
(12) Patent Application Publication
(10) Pub. No.: US 2018/0181712 A1
(43) Pub. Date: Jun. 28, 2018

(54) Systems and Methods for Patient-Provider Engagement

(71) Applicant: General Electric Company, Schenectady, NY (US)

(72) Inventors: Michelle Ensey, Seattle, WA (US); Danh Tran, Seattle, WA (US); Diya Deb, Seattle, WA (US); Amanda Mander, Seattle, WA (US); Chelsey Lewis, Waukesha, WI (US); Donald Sepulveda, Humble, TX (US)

(21) Appl. No.: 15/391,513

(22) Filed: Dec. 27, 2016

(51) Int. Cl. G06F 19/00; H04L 29/08

(52) U.S. Cl. CPC G06F 19/322; G06F 19/3406; H04L 67/10

(57) ABSTRACT

Certain examples provide systems and methods for patient-provider engagement. An example apparatus includes a workflow processor to identify a patient and determine a workflow for patient care, the workflow processor to divide a workflow into phases, each phase associating rules from a rules engine with at least one role, each phase including at least one activity specified by the rules, each activity involving at least one role and at least one associated task, alert, or suggestion for the at least one role specified by the rules, wherein the rules connect the activities of the phases of the workflow to an electronic medical record to automatically provide and receive data for a patient in each phase of the workflow. The example apparatus includes a phase monitor to monitor execution of the phases of the workflow and trigger at least one of the associated task, alert or suggestion.

### BACKGROUND

The statements in this section merely provide background information related to the disclosure and may not constitute prior art.

A challenge of current Electronic Medical Record (EMR) systems is a limited ability to support the complexity of medical practice activities. Activities include management, registration, rooming, encounter, visit summary, and billing. Current EMRs are limited to the encounter activity, large on-premise solutions or bolt-ons to existing systems add value or close technology gaps. Many EMRs were built when the technology was not as robust, and data entry was more valuable than data aggregation and big data management.

Additionally, with new regulations forcing a pay for performance healthcare system, patient compliance and evidence of care becomes increasingly important. Currently, non-discreet data is entered into the patient chart as a care plan, but that data is not searchable or analyzable as non-discreet data. Providers have a limited amount of time and cognitive energy and cannot devote time to properly understand the available data.

### BRIEF SUMMARY

Certain examples provide systems and methods for patient-provider engagement.

An example apparatus includes a rules engine including rules for workflow execution. The example apparatus includes a workflow processor to identify a patient and determine a workflow for care of the patient, the workflow processor to divide a workflow into phases, each phase associating rules from the rules engine with at least one role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow. The example apparatus includes a phase monitor to monitor execution of the phases of the workflow, the phase monitor to trigger at least one of the associated task, alert or suggestion to drive the workflow for care of the patient.

An example computer-implemented method includes identifying, using a processor, a patient. The example method includes determining, using the processor, a workflow for care of the patient. The example method includes identifying, using the processor, roles and rules in the workflow. The example method includes dividing a workflow into phases, each phase associating rules with each role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow. The example method includes monitoring execution of the phases of the workflow. The example method includes triggering at least one of the associated task, alert or suggestion to drive the workflow for care of the patient.

An example tangible computer-readable storage medium includes instructions which, when executed, particularly configure a processor to implement a method. The example method includes identifying a patient. The example method includes determining a workflow for care of the patient. The example method includes identifying roles and rules in the workflow. The example method includes dividing a workflow into phases, each phase associating rules with each role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow. The example method includes monitoring execution of the phases of the workflow. The example method includes triggering at least one of the associated task, alert or suggestion to drive the workflow for care of the patient.

Example computer-readable media, systems, and/or other apparatus can be used to implement methods disclosed herein.

### BRIEF DESCRIPTION OF THE DRAWINGS

The features and technical aspects of the system and method disclosed herein will become apparent in the following Detailed Description set forth below when taken in conjunction with the drawings in which like reference numerals indicate identical or functionally similar elements.

FIG. 1 shows a block diagram of an example healthcare-focused information system.

FIG. 2 shows a block diagram of an example healthcare information infrastructure including one or more systems.

FIG. 3 shows an example industrial internet configuration including a plurality of health-focused systems.

FIG. 4 illustrates an example clinical decision support system including an electronic medical record system and a rules engine.

FIG. 5 illustrates an example system in which the electronic medical record works with a cloud database and a batch rule engine.

FIG. 6 illustrates an example rules engine application container.

FIG. 7 illustrates a flow diagram of an example rules engine execution flow among rules engine components to execute a rule for a given input.

FIG. 8 illustrates a flow diagram of an example method for a batch process flow to provide recommendation and/or other data to a clinician based on patient history and facts.

FIG. 9 shows an example rules engine implemented in a cloud and interacting with a local, on-premise information system.

FIG. 10 illustrates an example clinical decision support system including a data and rules repository.

FIG. 11 illustrates an example implementation of a rules engine and associated repository embedded in one or more other clinical applications.

FIG. 12 provides a data flow for clinical quality reporting using the rules engine.

FIG. 13 illustrates an architectural block diagram of an example clinical decision support system including the rules engine.

FIG. 14 illustrates another example block diagram of a system integrating a partner system with a clinical decision support system and a clinical practice solutions and/or electronic medical records system.

FIG. 15 illustrates an example clinical decision support system leveraging the rules engine as part of the clinical decision support to generate an improved patient outcome.

FIG. 16 illustrates an example system implementing the rules engine and clinical decision support in the form of a workflow processor, a phase monitor, a rules engine, and an electronic medical records system.

FIG. 17 illustrates a visualization of a journey map for a healthcare workflow for a patient.

FIG. 18 illustrates a flow diagram of an example method of patient care plan composition, monitoring, and adjustment using the example workflow processor, phase monitor, rules engine, and electronic medical records.

FIG. 19 is a block diagram of an example processor platform capable of executing instructions to implement the example systems and methods of FIGS. 1-18.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. Overview

Care plans are discreet and/or non-discreet data entered into the electronic medical record organized by each care event. A care plan is organized by problem or condition and represents standard(s) and protocol(s) for patient care based on payer and clinical guideline(s). By organizing and correlating discrete and non-discrete care pathway data in a medical record to clinical problem(s), condition(s) and/or comorbidities, care plans become repeatable and measurable standards of care. Care plans can be based on a specific payer, clinical standards of practice, and/or clinician specific guidelines, for example. Furthermore, problem oriented organization of data relevant to the problem and/or condition becomes automatable and actionable at the point of care when relevant.

A care pathway uses electronic medical record (EMR) and payer data to recommend intervention(s), activities and/or tasks appropriate for a patient's problem or set of problems. Productivity can be further improved by using a rules engine in conjunction with data input automating workflow, activities and/or tasks, when possible, based on clinical decision support intervention and/or other types of rules. The rules drive automation for an EMR system using tasking, alerts, and/or recommendations, for example. Thus, various portions of medical practice activities (e.g., management, registration, rooming, encounter, visit summary, billing) can be completed by facilitating the workflow to eliminate manual processes. Care pathway recommendations and/or workflow elements that cannot be automated are served up in the system workflow for manual intervention in orchestration with the automated recommendations, workflow, activities and/or tasks, for example.

Certain examples use a role-based rules system to determine access, workflows, activities, tasks, alerts and suggestions to be presented to complete activities. The system also allows for both role-based rules and individual custom rules to be created. Certain examples provide an ability to drive page content navigation to complete tasks.

An example of care plans with care pathways organized by problem and/or condition is as follows. Suppose a patient is over the age of 13 and is consulting medical professional for problem and/or condition of routine medical care. Routine correlated rules advise a practitioner to inquire if the patient smokes. An inquiry response can be extrapolated into preventative actions and/or more complex problems and/or conditions related to smoking that should be considered in the care pathway for the patient. Furthermore, if the patient has family or other relevant histories documented, rules can advise interventions such as a mammogram for breast cancer screening.

Clinical goals allow for a provider to compare patient data to a reference data point as well as set a smaller achievable goal. For example, regardless of whether a patient value is out of a reference range, a patient may have a more achievable goal. A clinical goal allows a provider to provide evidence-based care and tracking of patient compliance. Certain examples provide system and methods to relate reference values to a patient result and allow for a provider to set other patient-specific goals.

Certain examples provide systems and methods to facilitate clinical problem and guideline-based clinical care through problem-oriented organization of clinical information, care plans, pathways, and goals. An example workflow introduces clinical information organized and correlated by medical decision (problem) in conjunction with guidelines and decision support at the point of care and assists users (e.g., EMR users, clinical practice management/clinical practice solution system (CPS) users, etc.) to identify gaps in patient care and improve care quality through structured care plans inside the workflow. In certain examples, productivity can be further improved by automating workflow based on clinical decision support and business process rules.

With new regulations forcing a pay-for-performance healthcare system, patient compliance and evidence of care becomes increasingly important. Providers have a limited amount of time and cognitive energy to apply to patient care. By providing a solution that decreases the amount of cognitive load and time required for initial and mundane diagnostics, providers can instead exert their cognitive energy on more complex conditions.

Organizing structured care plans, pathway, and goals around problems and/or conditions can help EMR users decrease cognitive load while inside their workflow to identify gaps in patient care and opportunities to improve care quality. Benchmark goals can help to prevent and improve overall health. By intervening earlier patient outcomes are also improved, medical cost of a life time decreases. Medical evidence is also validated or improved upon.

In prior systems, non-discrete data is entered into a patient chart as one or more care plans. In certain examples, by correlating the non-discrete information to a clinical condition and comorbidities, problem-oriented views of clinical data can be generated that are actionable at a point of care. Furthermore, parsing out clinical goals transforms the non-discrete data into discrete data that is searchable. Certain examples allow additional rules to be run and become part of decision making at a point of care to enable clinicians to act on the data.

Certain examples organize structured care plans, pathways and goals around problems and/or conditions to assist EMR and/or CPS users to identify gaps in patient care and improve care quality while inside their workflow. User productivity can be further improved by automating workflow based on clinical decision support and business process rules that provide standardization and reduce laborious and costly manual processes.

Organizations can create their own standards of care and/or protocols to be used as guidelines, processes and/or policies for the organizations. In certain examples, a plug-in product that authors guideline content that can be referenced outside of a patient visit workflow. By organizing by problems and conditions and tying them to rules and a rules engine, certain examples facilitate a workflow not achieved by prior EMR or CPS systems.

Alternatively, a plug-in product can be provided to author guideline content that can be referenced outside of a patient visit workflow, for example. Using machine learning technologies, unlabeled data can be provided around a subject area, such as smoking, and allow the system to determine points of intervention.

Prior EMRs are very transactional and involve much user data entry. Certain examples move the data entry burden and introduce some machine intelligence. Certain examples use system intelligence and power of data to improve user and patient workflow and patient treatment. For example, a patient is treated by listening, coming to a decision, and setting goals to evaluate how the patient is doing with the treatment. For example, if a user prescribes immoxicilin for 14 days, certain examples provide a listener device in the system to process the order amount and time. The listener identifies when the patient has picked up the prescription from a pharmacy, and, if the listener does not detect a transaction to indicate that the patient has picked up his or her prescription, then the listener device triggers a task/activity to contact patient and inquire regarding the prescription, contact the pharmacy, etc., to help ensure there is no barrier to patient pick up of the prescription (e.g., patient cannot afford a co-pay, patient has no transport to get to pharmacy, etc.). Thus, listeners can be wrapped around transactions and/or other background tasks in a patient care plan/workflow.

In certain examples, care plan goals can be associated with listener devices to monitor progress toward and/or achievement of those goals. For example, if a patient has problems related to low-density lipoprotein (LDL), a doctor can prescribe medication as well as recommend a modification to diet and exercise with a goal to reduce weight by three pounds in four weeks. A listener can be associated with the care plan and goal. If the listener follows and evaluates program and determines whether or not the goal has not been met in four weeks. Based on the outcome, recommendations can be generated (e.g., more intrusive interventions (e.g., weight loss counseling, hypnotherapist, medication, etc.) or less intrusive inventions, etc., based on positive or negative outcome).

Certain examples also automate patient care workflows. For example, if a physician places an order or refers a patient for an x-ray imaging, heart monitoring, etc., and the patient does not comply (e.g., because the patient does not have enough time, the patient does not have enough money, the patient is not interested, etc.), the physician is penalized for lack of care. A notification or alert regarding the penalty can be surfaced in the workflow such that the system identifies the order or referral as well as the lack of completion or follow-through and triggers a notification (e.g., a note to a care manager to follow up with the patient, etc.).

Certain examples also provide business process rules to indicate and/or document aspects of patient care to help ensure providers are paid correctly for work being done. A rule defines a timing and/or other condition for a corresponding behavior and can also include other behavior(s) to be executed in order to be paid by an insurer. In certain examples, the system parses and understands care protocol and payment guidelines and guides and guides a user through the guidelines to help ensure proper care and payment.

In certain examples, ambulatory data (e.g., some discrete data and some non-discrete data, etc.) is stored in a data repository, such as an EMR, and an authoring tool is provided to author medical guidelines in real time and/or substantially real time (e.g., given data transmission, processing, storage, and/or retrieval delay) with clinical decision support. For example, a user can author rules that indicate if certain conditions are met, then corresponding activities are executed. For example, if a diabetes code is identified and the patient is over age 45, then the patient is recommended for a foot examination every year. Rules can be written to leverage the environment and terminology.

For example, suppose a patient is a diabetic and should get an A1C every year. A terminology service looks for a Logical Observation Identifiers Names and Codes (LOINC) code of A1C, which triggers a rule to search for an A1C appointment on the patient's chart. If such an appointment is not found, the rule suggests and/or makes an A1C appointment for the patient to evaluate that patient's glycated hemoglobin A1C level of average (e.g., 3 month) plasma glucose concentration.

In another example, the system can evaluate EMR ambulatory data and use a rules engine to apply rules and produce a recommendation. The recommendation can be displayed via a graphical user interface (GUI), and a user can then order a hemoglobin A1C for the patient. Once the A1C result comes back and does not satisfy a parameter within a normal range, an additional recommendation can indicate more frequent A1C reviews, increase medication, etc. In certain examples, a payer can have a similar rule to the provider A1C rule recommending an A1C review every three months. The payer rule can come into the repository and trump the provider rule of once a year to set the schedule more frequently and bridge the information loop, for example.

In certain examples, data, rules, and/or processing, etc., can be located on-premises at a healthcare facility. In certain examples, data, rules, and/or processing, etc., can be provided in a cloud-based implementation (e.g., run through a cloud storage factory with recommendations manifesting in cloud orders, etc.). In a cloud-based implementation, an on-premise database is located in a cloud, so customers do not have to migrate data to a different database. Instead, users have a common data factory to leverage that data for batch rules, clinical decision support, etc.

Thus, certain examples facilitate improved care quality through application of rules, monitoring, and improved patient outcomes (e.g., patients are cheaper to care for, less likely to have certain events, etc.). Certain examples provide actionable insights at a right time and place. Information is provided inside a workflow at a point at which the information is relevant to the workflow. A rule runs and a result appears inside an order screen where a user is placing the order, for example. A recommendation modifies a user's screen in real time to impact his or her workflow in the moment when/where the user is making decisions related to the recommendation.

In certain examples, an electronic medical record system is used to build a composite solution for medical practice activities. The example system can include a database, information technology (IT) infrastructure, user interface (UI), task manager, front end, etc. Example medical practice activities include management, registration, rooming, encounter, visit summary, billing, etc. Using the EMR system, data can be converted to insights and associated action. Insights can be generated in context at a point of need in a workflow, for example. In contrast, prior EMR systems are limited to patient encounter activity on-premises without insight and associated action.

Certain examples provide a cloud-based EMR system and platform that uses both role-based and system rules to determine access, tasks, alerts and suggestions to be presented to complete requested work. The example system also allows for both role-based rules and individual custom rules to be created. Through a UI, page content navigation is driven to complete tasks in a healthcare workflow. For example, the system can be used to implement a cloud-based platform for ambulatory care delivery that can be extended through application programming interfaces (APIs) to support many roles and functions to provide value-based healthcare.

Certain examples provide an automated EMR system through use of customizable, role based task management, alerts, and suggestions within a context of medical practice activities including management, registration, rooming, encounter, visit summary, billing, etc. The example EMR supports and connects these activities into a single connected system to increase communication and task efficiency, for example.

Certain examples organize workflow tasks, insights, and actions into a journey map that is actionable to practitioners and clinical systems, such as the EMR system. Certain examples provide systems and methods for workflow rules to drive automation for an EMR system using tasking, alerts, suggestions, etc. Example methods and systems facilitate completion of various portions of medical practice activities (e.g., management, registration, rooming, encounter, visit summary, billing, etc.) through facilitation of a workflow to eliminate use of ambiguous and duplicate tasks, invisible system states, and undefined role based rules, for example. Certain examples use role-based rules systems and methods to determine access, tasks, alerts and suggestions to be presented to complete requested work in conjunction with role-based rules and/or individual custom rules and content navigation to complete tasks.

As will be described further below, certain examples can integrate with and operate in a variety of healthcare environments and impact a variety of healthcare scenarios and data through sensing, decision support, workflow management, and control. The following section provides some context and example environment for the presently disclosed technology described further in the subsequent section below.

### II. Example Operating Environments

Health information, also referred to as healthcare information and/or healthcare data, relates to information generated and/or used by a healthcare entity. Health information can be information associated with health of one or more patients, for example. Health information may include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure may include a centralized capability including, for example, a data repository, reporting, discrete data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. Example SOA includes a three-fold interoperability strategy including a central repository (e.g., a central repository built from Health Level Seven (HL7) transactions), services for working in federated environments, and visual integration with third-party applications. Certain examples provide portable content enabling plug'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

A. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

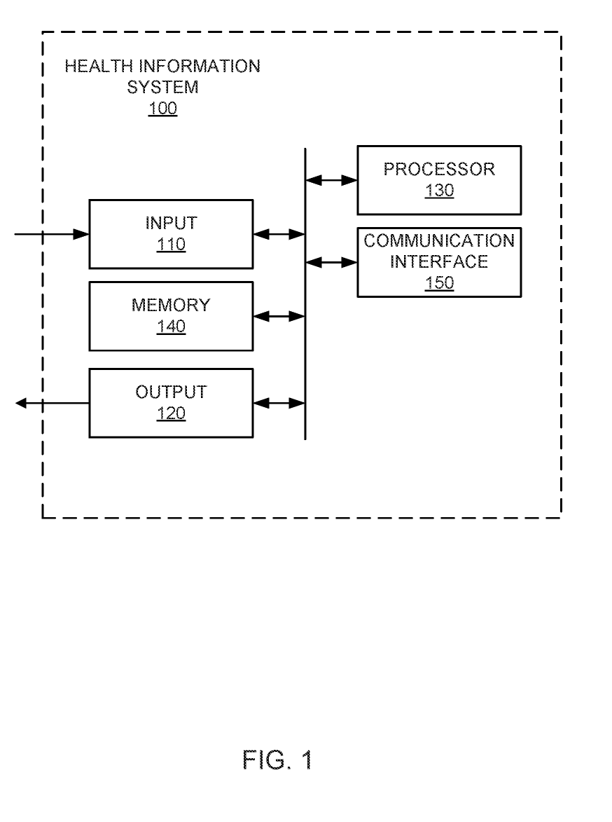

Turning now to the figures, FIG. 1 shows a block diagram of an example healthcare-focused information system 100. Example system 100 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 1, the example information system 100 includes an input 110, an output 120, a processor 130, a memory 140, and a communication interface 150. The components of example system 100 can be integrated in one device or distributed over two or more devices.

Example input 110 may include a keyboard, a touch-screen, a mouse, a trackball, a track pad, optical barcode recognition, voice command, etc. or combination thereof used to communicate an instruction or data to system 100. Example input 110 may include an interface between systems, between user(s) and system 100, etc.

Example output 120 can provide a display generated by processor 130 for visual illustration on a monitor or the like. The display can be in the form of a network interface or graphic user interface (GUI) to exchange data, instructions, or illustrations on a computing device via communication interface 150, for example. Example output 120 may include a monitor (e.g., liquid crystal display (LCD), plasma display, cathode ray tube (CRT), etc.), light emitting diodes (LEDs), a touch-screen, a printer, a speaker, or other conventional display device or combination thereof.

Example processor 130 includes hardware and/or software configuring the hardware to execute one or more tasks and/or implement a particular system configuration. Example processor 130 processes data received at input 110 and generates a result that can be provided to one or more of output 120, memory 140, and communication interface 150. For example, example processor 130 can take user annotation provided via input 110 with respect to an image displayed via output 120 and can generate a report associated with the image based on the annotation. As another example, processor 130 can process updated patient information obtained via input 110 to provide an updated patient record to an EMR via communication interface 150.

Example memory 140 may include a relational database, an object-oriented database, a data dictionary, a clinical data repository, a data warehouse, a data mart, a vendor neutral archive, an enterprise archive, etc. Example memory 140 stores images, patient data, best practices, clinical knowledge, analytics, reports, etc. Example memory 140 can store data and/or instructions for access by the processor 130. In certain examples, memory 140 can be accessible by an external system via the communication interface 150.

In certain examples, memory 140 stores and controls access to encrypted information, such as patient records, encrypted update-transactions for patient medical records, including usage history, etc. In an example, medical records can be stored without using logic structures specific to medical records. In such a manner, memory 140 is not searchable. For example, a patient's data can be encrypted with a unique patient-owned key at the source of the data. The data is then uploaded to memory 140. Memory 140 does not process or store unencrypted data thus minimizing privacy concerns. The patient's data can be downloaded and decrypted locally with the encryption key.

For example, memory 140 can be structured according to provider, patient, patient/provider association, and document. Provider information may include, for example, an identifier, a name, and address, a public key, and one or more security categories. Patient information may include, for example, an identifier, a password hash, and an encrypted email address. Patient/provider association information may include a provider identifier, a patient identifier, an encrypted key, and one or more override security categories. Document information may include an identifier, a patient identifier, a clinic identifier, a security category, and encrypted data, for example.

Example communication interface 150 facilitates transmission of electronic data within and/or among one or more systems. Communication via communication interface 150 can be implemented using one or more protocols. In some examples, communication via communication interface 150 occurs according to one or more standards (e.g., Digital Imaging and Communications in Medicine (DICOM), Health Level Seven (HL7), ANSI X12N, etc.). Example communication interface 150 can be a wired interface (e.g., a data bus, a Universal Serial Bus (USB) connection, etc.) and/or a wireless interface (e.g., radio frequency, infrared (IR), near field communication (NFC), etc.). For example, communication interface 150 may communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

B. Example Healthcare Infrastructure

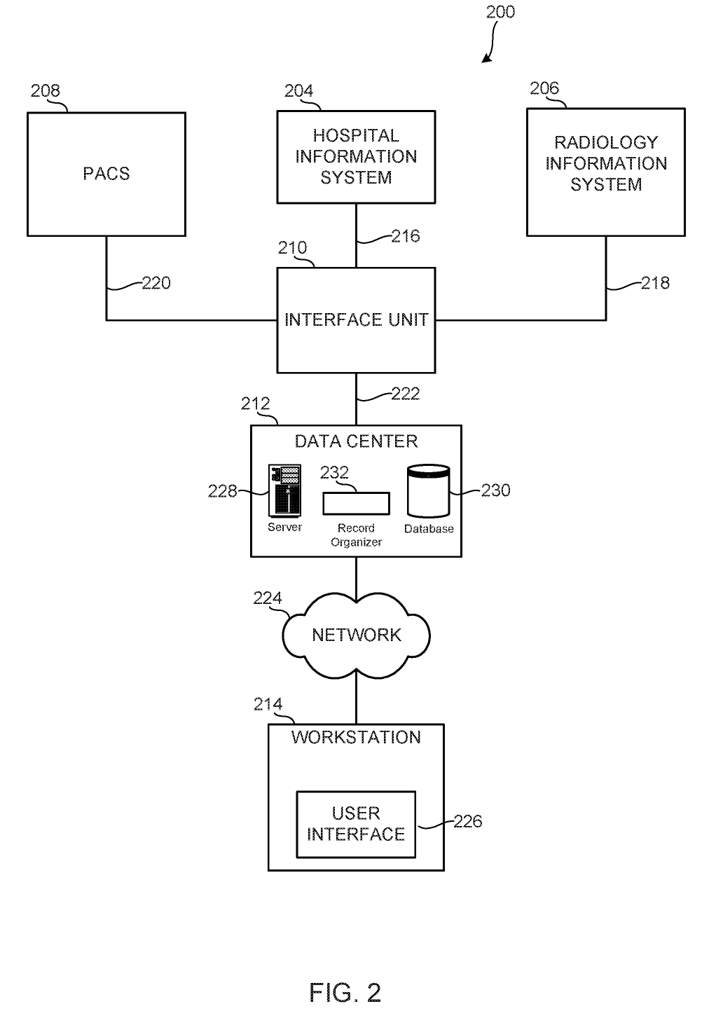

FIG. 2 shows a block diagram of an example healthcare information infrastructure 200 including one or more subsystems such as the example healthcare-related information system 100 illustrated in FIG. 1. Example healthcare system 200 includes a HIS 204, a RIS 206, a PACS 208, an interface unit 210, a data center 212, and a workstation 214. In the illustrated example, HIS 204, RIS 206, and PACS 208 are housed in a healthcare facility and locally archived. However, in other implementations, HIS 204, RIS 206, and/or PACS 208 may be housed within one or more other suitable locations. In certain implementations, one or more of PACS 208, RIS 206, HIS 204, etc., may be implemented remotely via a thin client and/or downloadable software solution. Furthermore, one or more components of the healthcare system 200 can be combined and/or implemented together. For example, RIS 206 and/or PACS 208 can be integrated with HIS 204; PACS 208 can be integrated with RIS 206; and/or the three example information systems 204, 206, and/or 208 can be integrated together. In other example implementations, healthcare system 200 includes a subset of the illustrated information systems 204, 206, and/or 208. For example, healthcare system 200 may include only one or two of HIS 204, RIS 206, and/or PACS 208. Information (e.g., scheduling, test results, exam image data, observations, diagnosis, etc.) can be entered into HIS 204, RIS 206, and/or PACS 208 by healthcare practitioners (e.g., radiologists, physicians, and/or technicians) and/or administrators before and/or after patient examination. One or more of the HIS 204, RIS 206, and/or PACS 208 can communicate with equipment and system(s) in an operating room, patient room, etc., to track activity, correlate information, generate reports and/or next actions, and the like.

The HIS 204 stores medical information such as clinical reports, patient information, and/or administrative information received from, for example, personnel at a hospital, clinic, and/or a physician's office (e.g., an EMR, EHR, PHR, etc.). RIS 206 stores information such as, for example, radiology reports, radiology exam image data, messages, warnings, alerts, patient scheduling information, patient demographic data, patient tracking information, and/or physician and patient status monitors. Additionally, RIS 206 enables exam order entry (e.g., ordering an x-ray of a patient) and image and film tracking (e.g., tracking identities of one or more people that have checked out a film). In some examples, information in RIS 206 is formatted according to the HL-7 (Health Level Seven) clinical communication protocol. In certain examples, a medical exam distributor is located in RIS 206 to facilitate distribution of radiology exams to a radiologist workload for review and management of the exam distribution by, for example, an administrator.

PACS 208 stores medical images (e.g., x-rays, scans, three-dimensional renderings, etc.) as, for example, digital images in a database or registry. In some examples, the medical images are stored in PACS 208 using the Digital Imaging and Communications in Medicine (DICOM) format. Images are stored in PACS 208 by healthcare practitioners (e.g., imaging technicians, physicians, radiologists) after a medical imaging of a patient and/or are automatically transmitted from medical imaging devices to PACS 208 for storage. In some examples, PACS 208 can also include a display device and/or viewing workstation to enable a healthcare practitioner or provider to communicate with PACS 208.

The interface unit 210 includes a hospital information system interface connection 216, a radiology information system interface connection 218, a PACS interface connection 220, and a data center interface connection 222. Interface unit 210 facilities communication among HIS 204, RIS 206, PACS 208, and/or data center 212. Interface connections 216, 218, 220, and 222 can be implemented by, for example, a Wide Area Network (WAN) such as a private network or the Internet. Accordingly, interface unit 210 includes one or more communication components such as, for example, an Ethernet device, an asynchronous transfer mode (ATM) device, an 802.11 device, a DSL modem, a cable modem, a cellular modem, etc. In turn, the data center 212 communicates with workstation 214, via a network 224, implemented at a plurality of locations (e.g., a hospital, clinic, doctor's office, other medical office, or terminal, etc.). Network 224 is implemented by, for example, the Internet, an intranet, a private network, a wired or wireless Local Area Network, and/or a wired or wireless Wide Area Network. In some examples, interface unit 210 also includes a broker (e.g., a Mitra Imaging's PACS Broker) to allow medical information and medical images to be transmitted together and stored together.

Interface unit 210 receives images, medical reports, administrative information, exam workload distribution information, and/or other clinical information from the information systems 204, 206, 208 via the interface connections 216, 218, 220. If necessary (e.g., when different formats of the received information are incompatible), interface unit 210 translates or reformats (e.g., into Structured Query Language (“SQL”) or standard text) the medical information, such as medical reports, to be properly stored at data center 212. The reformatted medical information can be transmitted using a transmission protocol to enable different medical information to share common identification elements, such as a patient name or social security number. Next, interface unit 210 transmits the medical information to data center 212 via data center interface connection 222. Finally, medical information is stored in data center 212 in, for example, the DICOM format, which enables medical images and corresponding medical information to be transmitted and stored together.

The medical information is later viewable and easily retrievable at workstation 214 (e.g., by their common identification element, such as a patient name or record number). Workstation 214 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. Workstation 214 receives commands and/or other input from a user via, for example, a keyboard, mouse, track ball, microphone, etc. Workstation 214 is capable of implementing a user interface 226 to enable a healthcare practitioner and/or administrator to interact with healthcare system 200. For example, in response to a request from a physician, user interface 226 presents a patient medical history. In other examples, a radiologist is able to retrieve and manage a workload of exams distributed for review to the radiologist via user interface 226. In further examples, an administrator reviews radiologist workloads, exam allocation, and/or operational statistics associated with the distribution of exams via user interface 226. In some examples, the administrator adjusts one or more settings or outcomes via user interface 226.

Example data center 212 of FIG. 2 is an archive to store information such as images, data, medical reports, and/or, more generally, patient medical records. In addition, data center 212 can also serve as a central conduit to information located at other sources such as, for example, local archives, hospital information systems/radiology information systems (e.g., HIS 204 and/or RIS 206), or medical imaging/storage systems (e.g., PACS 208 and/or connected imaging modalities). That is, the data center 212 can store links or indicators (e.g., identification numbers, patient names, or record numbers) to information. In the illustrated example, data center 212 is managed by an application server provider (ASP) and is located in a centralized location that can be accessed by a plurality of systems and facilities (e.g., hospitals, clinics, doctor's offices, other medical offices, and/or terminals). In some examples, data center 212 can be spatially distant from HIS 204, RIS 206, and/or PACS 208.

Example data center 212 of FIG. 2 includes a server 228, a database 230, and a record organizer 232. Server 228 receives, processes, and conveys information to and from the components of healthcare system 200. Database 230 stores the medical information described herein and provides access thereto. Example record organizer 232 of FIG. 2 manages patient medical histories, for example. Record organizer 232 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by system 200 via a software-as-a-service (SaaS) implementation over a cloud or other computer network, for example. In certain examples, all or part of system 200 can also be provided via platform as a service (PaaS), infrastructure as a service (IaaS), etc. For example, system 200 can be implemented as a cloud-delivered Mobile Computing Integration Platform as a Service. A set of consumer-facing Web-based, mobile, and/or other applications enable users to interact with the PaaS, for example.

C. Industrial Internet Examples

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, providing a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

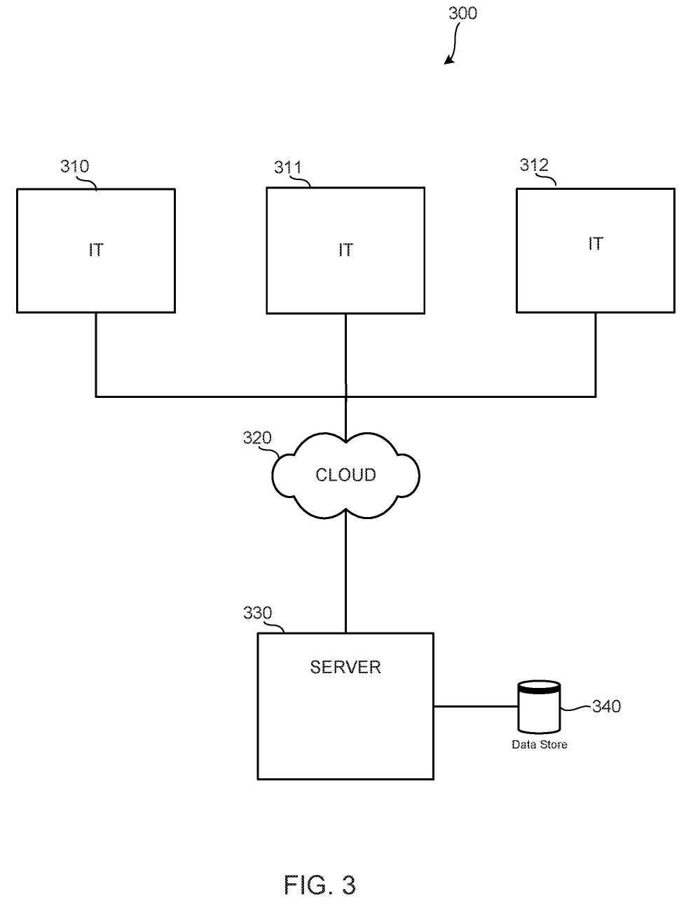

FIG. 3 illustrates an example industrial internet configuration 300. Example configuration 300 includes a plurality of health-focused systems 310-312, such as a plurality of health information systems 100 (e.g., PACS, RIS, EMR, etc.) communicating via industrial internet infrastructure 300. Example industrial internet 300 includes a plurality of health-related information systems 310-312 communicating via a cloud 320 with a server 330 and associated data store 340.

As shown in the example of FIG. 3, a plurality of devices (e.g., information systems, imaging modalities, etc.) 310-312 can access a cloud 320, which connects the devices 310-312 with a server 330 and associated data store 340. Information systems, for example, include communication interfaces to exchange information with server 330 and data store 340 via the cloud 320. Other devices, such as medical imaging scanners, patient monitors, etc., can be outfitted with sensors and communication interfaces to enable them to communicate with each other and with the server 330 via the cloud 320.

Thus, machines 310-312 within system 300 become “intelligent” as a network with advanced sensors, controls, analytical based decision support and hosting software applications. Using such an infrastructure, advanced analytics can be provided to associated data. The analytics combines physics-based analytics, predictive algorithms, automation, and deep domain expertise. Via cloud 320, devices 310-312 and associated people can be connected to support more intelligent design, operations, maintenance, and higher server quality and safety, for example.

Using the industrial internet infrastructure, for example, a proprietary machine data stream can be extracted from a device 310. Machine-based algorithms and data analysis are applied to the extracted data. Data visualization can be remote, centralized, etc. Data is then shared with authorized users, and any gathered and/or gleaned intelligence is fed back into the machines 310-312.

D. Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves.

E. Example Methods of Use

Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, reviewing and reporting on an image, executing orders for specific care, signing off on orders for a discharge, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, dispatching room cleaning and/or patient transport, and/or any other action useful in processing healthcare information or causing critical path care activities to progress. The defined clinical workflows may include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc.

### III. Example Patient Care Workflow Systems and Methods

Certain examples facilitate a patient journey and provider workflow through rules engine-driven scenario mapping. Certain examples provide enhanced clinical decision support for task orders, suggestions, etc., as well as improved care management, case management, registration, billing, etc. Certain examples provide a care team ecosystem to facilitate a workflow for patient-provider interaction for patient treatment according to a care plan or pathway. Certain examples leverage rules and available data (e.g., electronic medical record data, device data, imaging data, financial data, resource status data, etc.) to drive tasks and react to failures in compliance to suggest provider action.

Certain examples leverage the patient-provider workflow and identify roles in a healthcare environment. The workflow is divided into phases, and, for each phase, rules are associated with each role. Each phase includes at least one activity specified by the rules, and each activity involves at least one role and at least one associated task, alert, and suggestion for the at least one role specified by the rules. In certain examples, the rules connect the activities of the phases of the workflow to an electronic medical record system to automatically provide and receive data for a patient in each phase of the workflow. The phases of the workflow along with activities and data form a patient journey map to guide the patient, healthcare providers, and healthcare systems through the workflow, for example. Feedback allows the system to provide intelligence for successes, failures, omissions, etc., to help ensure certain information (e.g., need a new copy of patient's insurance card, etc.) is available and used to help drive the workflow.

In a fee-for-service environment, patients can go to a variety of providers for service without penalty. Providers can enter into value-based contracts which give the provider responsibility for a certain number of patients (e.g., five thousand patients, etc.). A doctor can view his or her patients, track their activity, and track what they're being measured against.

Certain examples connecting payer and provider data in the workflow. Certain examples remove an intermediary and enable real-time feedback and authorization for procedures, orders, etc., by leveraging system APIs to communicate between disparate healthcare systems with a rules engine in between the systems. For example, if a physician requests a computed tomography (CT) scan for a patient, rule(s) provided by the rules engine indicate that such an order requires authorization because the patient has a certain insurance and a configuration file for that insurance indicates authorization is needed for the order, associated with a particular code (e.g., LOINC code, ICD-10 code, etc.). Certain examples surface this issue by alerting the provider through the connected system APIs and rules engine to prompt the provider to ask for authorization and confirm that they can/wish to proceed. If so, the systems contact the payer and obtain authorization to proceed. Then, when the order for a CT scan is transmitted to an imaging center, the authorization and other information/documentation is transmitted with the order so the imaging center does not need to follow up and ask for additional information, for example. The rules engine works with an electronic medical records system, billing system, and/or other healthcare system to facilitate the automated workflow between systems while reducing or minimizing human action, for example.

Certain examples provide a clinical decision support system 400 including an EMR 410 and a rules engine 420. The example EMR 410 can be operated in a real time and/or batch mode. In a real-time mode, the rule engine 420 is triggered at a plurality of preconfigured trigger points in the EMR application 410. The EMR 410 pulls clinical patient data (e.g., facts) from an EMR database and sends the patient data to the rule engine 420 to generate a recommendation. The rule engine 420 loads one or more rules and applies the one or more rules to the clinical facts to generate a recommendation. The EMR 410 stores the recommendation (e.g., in a database on the cloud, etc.) and outputs (e.g., displays, etc.) the recommendation to a clinician.

In certain examples, a batch mode is triggered when data is made available on the cloud. The batch process pulls clinical facts from the data on the cloud and applies clinical batch rules to generate a recommendation. The recommendation persists on the cloud at the end of the batch process. During a patient encounter, for example, when a clinician logs into the EMR 410, the recommendation is pulled and displayed to the user.

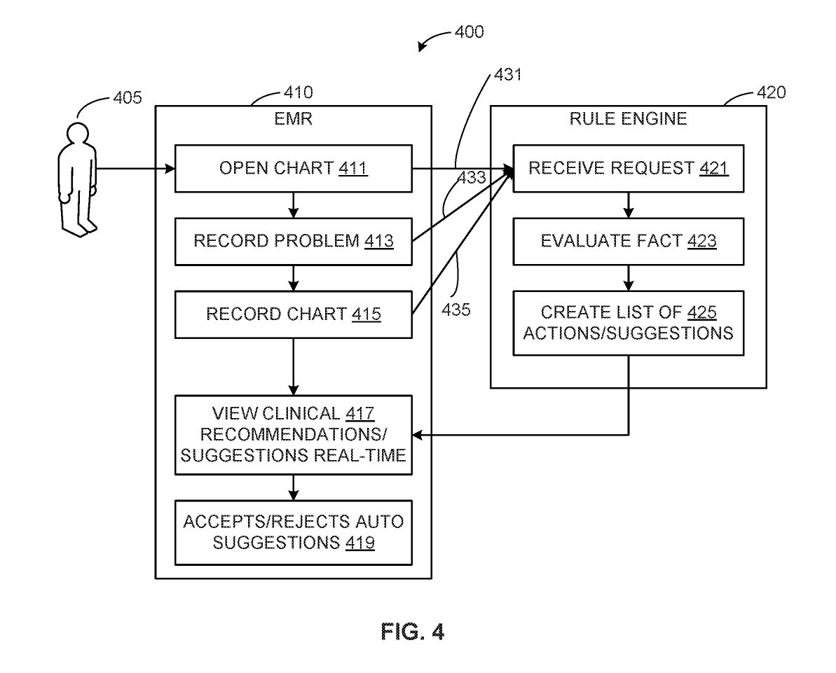

Turning to the example of FIG. 4, the physician 405 opens a patient chart 411 via the EMR 410. Opening the patient chart 411 triggers 431 the rule engine 420 to receive a request 421 for a recommendation. At the EMR 410, a patient problem is recorded 413, which also triggers 433 a request 421 at the rule engine 420. The patient chart is recorded 415 at the EMR 410, which triggers 435 another request 421 at the rule engine 420. The rule engine 420 evaluates facts 423 and creates a list of actions and/or suggestions 425 based on rules applied to the data. The rule engine 420 generates a response 437 based on the actions and/or suggestions. The EMR 410 receives the response 437 and, based on the response 437, generates clinical recommendations and/or suggestions 417 in real time and/or substantially real time given data retrieval, processing, and/or transmission delay. The EMR 410 accepts and/or rejects 419 the automatically generated recommendations and/or suggestions (e.g., based on user input, rules, other stored data, etc.).

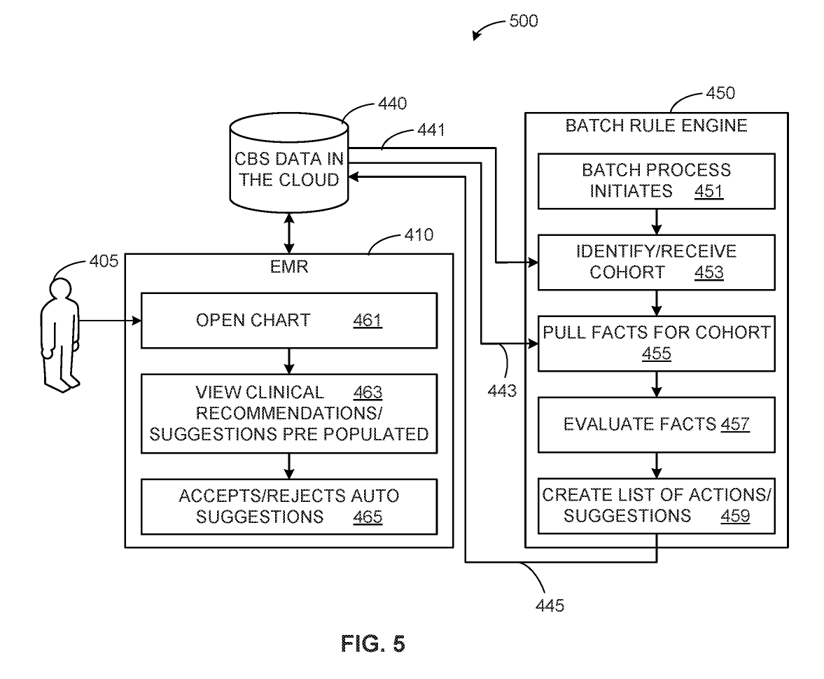

FIG. 5 illustrates an example system 500 in which the EMR 410 works with a cloud database 440 and a batch rule engine 450. As shown in the example of FIG. 5, the physician 405 opens a chart 461 via the EMR 410. Patient data is retrieved from and/or provided to the cloud database 440. The cloud-based data 440 is batched as a cohort 441 and provided to the batch rule engine 450. In the batch rule engine 450, a batch process initiates 451 and the cohort 441 is identified and/or received 453. The batch rule engine 450 pulls 455 facts 443 from the database 440 based on the cohort 441 and evaluates 457 the facts 443 with respect to rules of the batch rule engine 450. The batch rule engine 450 generates 459 a list of actions and/or suggestions provided as a response 445 to the cloud database 440 based on the actions and/or suggestions. The EMR 410 can query the cloud database 440 to view pre-populated clinical recommendations and/or suggestions 463 in real time and/or substantially real time given data retrieval, processing, and/or transmission delay. The EMR 410 accepts and/or rejects 465 the automatically generated recommendations and/or suggestions (e.g., based on user input, rules, other stored data, etc.).

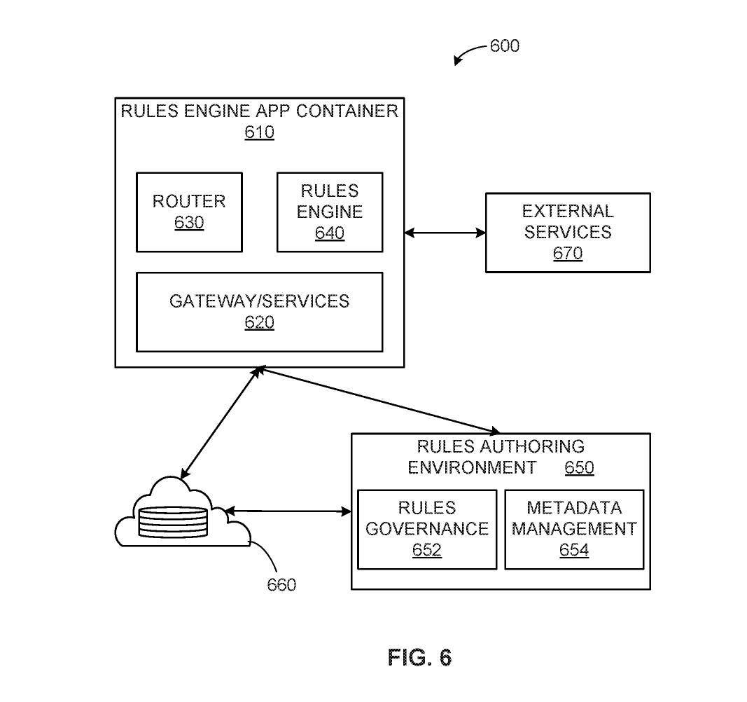

FIG. 6 illustrates an example rules engine application container 610 including a gateway/services 620, a router 630, and a rules engine 640 (e.g., the rules engine 420, rules engine 450, and/or other rules engine, etc.). The example gateway and/or other communication services 620 includes one or more end points, Representational State Transfer (REST) architecture with JavaScript Object Notation (JSON) for data interchange, discovery, audit, logging, security, monitoring, etc. The gateway services 620 provides a point of entry for rules engine 640 requests. An application program interface (API) for the rules engine 640 is exposed for access, such as via a REST endpoint over HTTPS, etc. An input and output payload can be implemented using a data model, such as a data model from the Fast Healthcare Interoperability Resources (FHIR) Draft Standard for Trial Use (DTSU 2) Specification. The gateway services 620 are responsible for cross-cutting functions such as logging, security, auditing, etc.

The example router 630 includes a rules set selector, rules metadata template(s), mapping, etc. The example rules engine 640 provides execution of rules according to a rule set/policy, for example. In certain examples, the router 630 fetches pre-requisite data for rule execution, validate clinical facts, and provide data and facts to the rules engine 640 to generate a recommendation. Once the rules engine 640 provides the recommendation, the router 630 post-processes the data before providing the data to the gateway server 620.

The example rules engine application container 610 interacts with a rules authoring environment 650. The example rules authoring environment 650 includes rules governance 652 and metadata management 654, for example. Rules can be stored in a storage 660, for example. The example rules engine application container 610 also interacts with one or more external services 670 such as a terminology service, fact provider service, and/or other rules, workflow and/or event providing service (e.g., Drools engine, etc.).

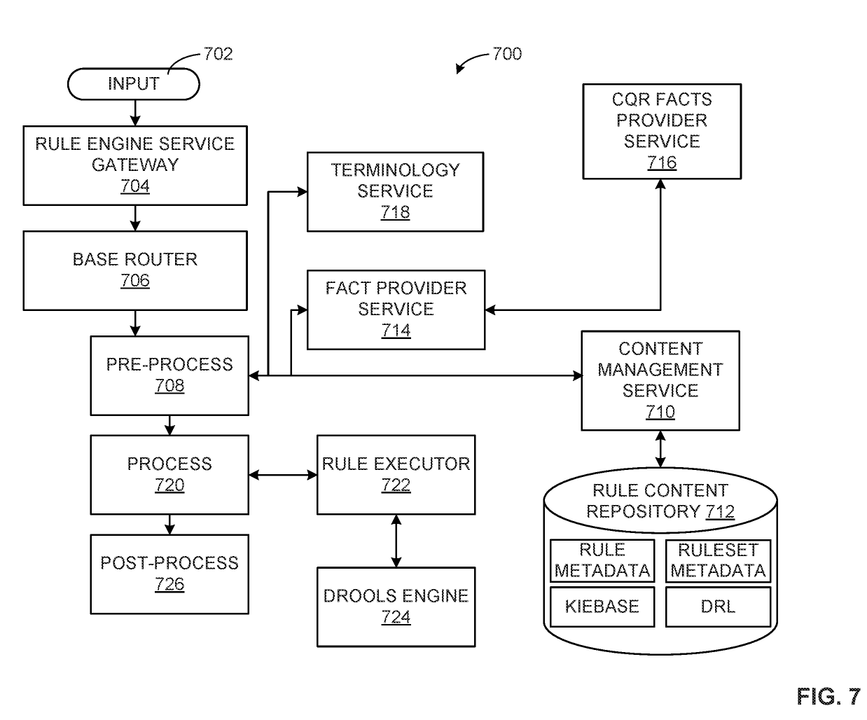

FIG. 7 illustrates a flow diagram of an example rules engine execution flow 700 among rules engine 640 components to build and execute a rule for a given input. At block 702, an input is provided to the rules engine 640 to generate an output. The example input 702 can include one or more of a rule set identifier, a tenant identifier, a specialty identifier, a user identifier, an “as of” date, fact(s), etc. The generated output can include a list of actions, for example. A rule engine service gateway 704 provides the input 702 to a base router 706.

At block 708, the data is pre-processed. For example, the input 702 can be processed with a fact provider service 714 to verify and/or supplement fact(s) provided in the input and/or provide fact(s) (e.g., from a Clinical Quality Reporting (CQR) fact provider service 816, etc.) in response to identifier(s) provided in the input. A terminology service 718 provides and/or adjusts proper terminology for a rule in accordance with the fact(s) and/or identifier(s) provided in the input 702. Pre-processing 7u08 can also include accessing a rule content repository 712 via a content management service 710. The example rule content repository 712 includes rule metadata, ruleset metadata, a Drools rule language (DRL) core, Kiebase and/or other application knowledge definition repository, etc.

Retrieved rule, fact, and/or terminology information is provided with the input 702 for processing at block 722. During processing 722, a rule executor 722 calls a rules execution engine such as a Drools engine 724 to execute the rule based on provided fact(s), identifier(s), metadata, etc. The result is provided for post-processing at block 726 (e.g., to clean up, frame, present, and/or otherwise prepare result(s) for output, etc.).

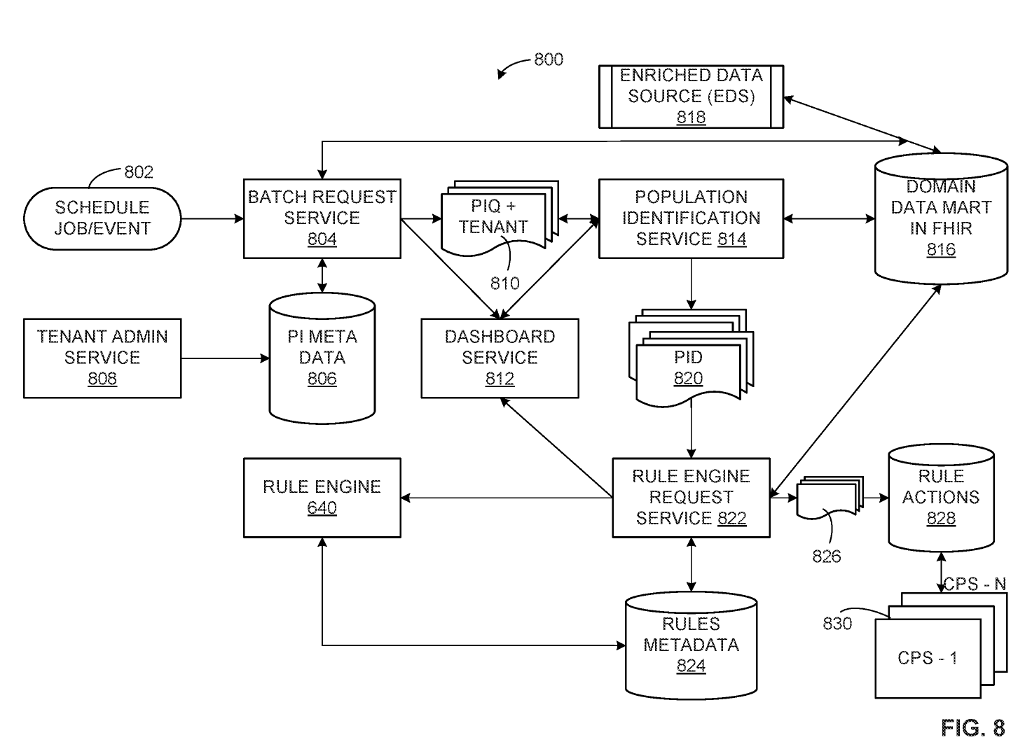

FIG. 8 illustrates a flow diagram of an example method 800 for a batch process flow to provide recommendation and/or other data to a clinician based on patient history and facts. For example, the batch process for clinical decision support helps in analyzing thousands of patients during a non-peak time to generate recommendations in advance of a physician-patient encounter. Services included in the batch flow help provide a workflow to identify patients, executed rules, and persist recommendations.

At block 802, a job or event is scheduled based on a trigger generated from an update of domain data. The scheduled job/event is provided to a batch request service 804 with associated metadata for a given tenant (e.g., user, job, event, etc.). The batch request service 804 communicates with patient identifier metadata 806. A tenant administrator service 908 works with the patient identifier metadata 806 to generate a configuration for each tenant. The configuration includes metadata 806 such as tenant, patient identification and qualification (PIQ), ruleset, etc.

In certain examples, the batch flow is provided via a cloud-based application to service hundreds of tenants such as hospitals, ambulatory care centers, etc. For each tenant, a PIQ message is placed in a Patient Identifier Request (PIR) queue 810 with a tenant identifier, which can be used by downstream components for further processing. Information can also be provided to a dashboard service 812 for analysis and display.

The PIR is provided from the queue 810 to a population identification service 814. The population identification service 814 can be implemented, for example, as a REST service that can be invoked by another service, component, etc. The population identification service 814 watches the PIR queue 810 and processes received messages. For each tenant, the service 814 identifies patients (e.g., all patients or a subset created using a filter criterion to select patients based on appointment date, age, other criterion, etc.), and an individual message is created and placed in the rule execution queue 820.

Thus, the population identification service 814 constructs a query and pulls a patient identifier (PID) from a domain data mart 816 (e.g., a Fast Health Interoperability Resources (FHIR) domain data mart, etc.) which includes patient data from one or more enriched data sources (EDS) 818, for example. In certain examples, the data mart 816 runs with a patient FHIR service to provide patient information in the FHIR model. The population identification service 814 can use the FHRI model and associated service to fetch details for a patient. After retrieval, the population identification service 814 places the PID into a rule execution request queue 820.

For example, once the request is successfully processed, an entry is made on a service bus based PIR queue 820. The rule engine request service 822 pulls a message from the rule execution queue 820 and extracts metadata from a rules metadata 824. The request service 822 creates an input from the PID and metadata and facts retrieved from the data store 816. The request service 822 provides the input to the rules engine 640. The rules to be run as part of the batch process can be configured using property settings, for example. Rules can be tenant-specific, tenant-agnostic, etc.

For each identified patient, patient facts are pulled from an external repository 816 and then fed to the rules engine 640. The rules engine processes the data and provides one or more recommendations, which is/are then persisted via a rules result service 826. The rules result/action service 826 persists recommended actions based on execution of the rule with respect to the patient. The service 826 persists or stores recommended actions(s) as records 830 in a rules results repository 828. In certain examples, the recommendations are split into single actions so that independent processing can be performed against each action. If there are no recommendations are provided in the rules response, a record 830 with an empty action can be persisted, for example.

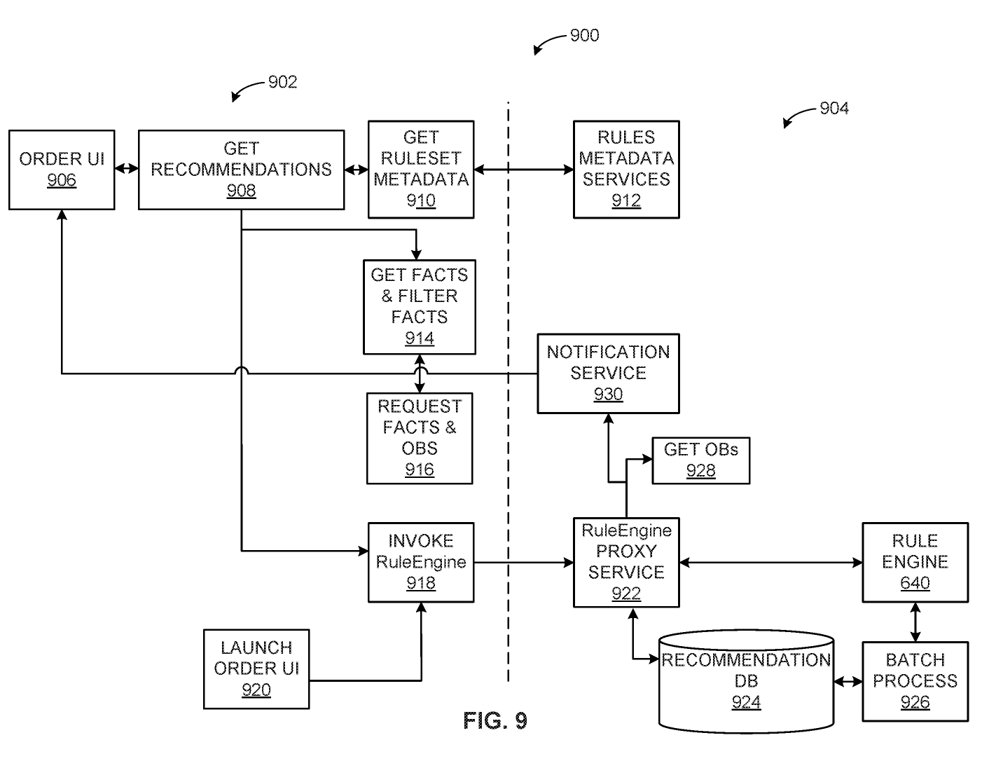

In certain examples, the rules engine 640 works with and/or is integrated with a clinical practice management system and/or other healthcare information system. As shown in the example system 900 of FIG. 9, the rules engine 640 can be located in the cloud 902 and interact with a local, on-premise information system 904.

At block 906, an order user interface (UI) can be used to add a problem (e.g., associated with a patient) via the on-premise information system 902 (e.g., a practice management system, electronic medical record, etc.). At block 908, recommendation(s) for rule formation are retrieved from the information system 902. At block 910, ruleset metadata is retrieved. After retrieving the ruleset metadata, the ruleset is provided to a rules metadata services 912 in the cloud 904.

At block 914, facts are requested and filtered. For example, patient information and/or other facts relating to rules are requested and filtered according to patient, ruleset relevance, etc. At block 916, facts and observations are requested and retrieved (e.g., from the on-premise information system 902) for filtering at block 914. At block 918, the rule engine 640 is invoked using the facts and rules. At block 920, the order UI can be launched asynchronously to invoke the rule engine 640 (block 918) and batch recommendation via the on-premise information system 902, for example.

At block 922, a proxy service for the rule engine 640 facilitates invocation of the rule engine 640 via the cloud 904. The proxy service accesses a recommendation database 924 and batch process 926 in conjunction with the rule engine 640. The rule engine 640 provides a recommendation in the recommendation database 924 for one or more rulesets and facts via the batch process 926. The proxy service 922 can retrieve observation information 928 and leverage a notification service 930 to provide an output via the user interface 906.

Thus, patient facts can be made available in the on-premise information system 902 (e.g., practice management system client cache, etc.) and can be filtered. Requests and recommendations can be batched and executed with the rule engine 640 via the cloud 904 to generate a notification for user(s) generating an order for a patient (e.g., including users who have navigated away from the order screen, etc.).

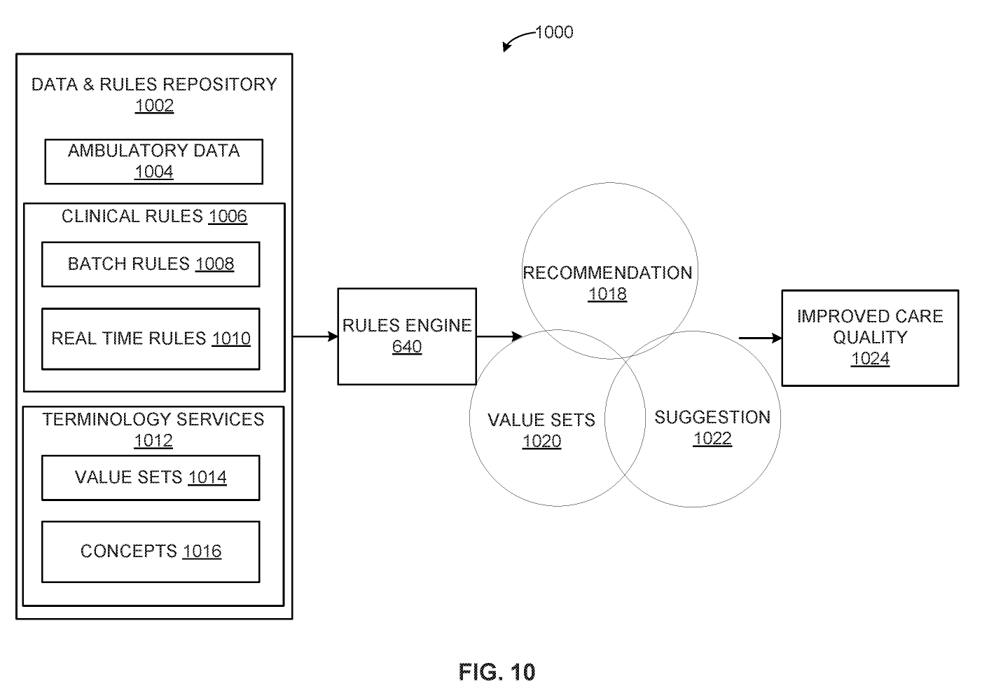

FIG. 10 illustrates an example clinical decision support system 1000 including a data and rules repository 1002. The example repository 1002 includes ambulatory data 1004, clinical rules 1006, and terminology services 1012. The example ambulatory data 1004 includes information such as patient identifier, procedure identifier, order, observation, medication order, medication, immunization, care goal, family history, encounter, problem, allergy intolerance, etc. The rules engine 640 leverages the ambulatory data 1004 using rules 1006 and terminology services 1012. The example clinical rules 1006 include batch rules 1008 and real time rules 1010 (see, e.g., the description of FIGS. 4-10). The example terminology services 1012 includes value set(s) 1014 and concept(s) 1016 to support the interpretation of data 1004 according to the rules 1006 by the rules engine 640, for example. The rules engine 640 generates a recommendation 1018, a value set 1020, and/or a suggestion 1022 to facilitate improved care quality 1024.

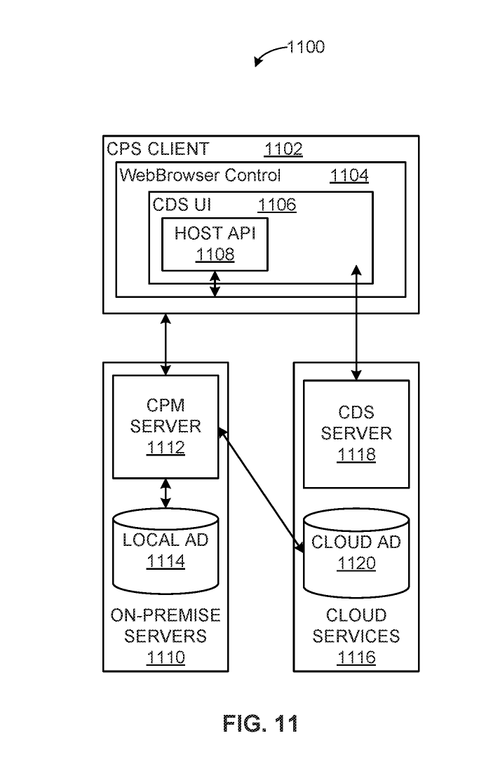

In certain examples, the rules engine 640 and associated repository 1002 can be embedded in one or more other clinical applications 1100. For example, as shown in FIG. 11, a CPS client 1102 includes a web browser control 1104, a clinical decision support (CDS) user interface 1106, and a host API 1108. The CPS client 1102 communicates with one or more on-premise servers 1110 and one or more cloud-based and/or otherwise remote servers 1116. Each on-premise server 1110 includes a clinical practice management (CPM) server 1112 and a local active directory (AD) 1114. Each cloud-based server 1116 includes a clinical decision support (CDS) server 1118 and a cloud AD 1120. The cloud AD 1120 can provide information to the CPM server 1112, for example.

Thus, a user logs in via the CPS client 1102, and the CPM server 1112 can authenticate the user via the local AD 1114 as well as the cloud AD 1120. The user invokes orders, and the CPM server 1112 loads the clinical decision support 1118 address (e.g., uniform resource locator (URL), etc.) in the Web Browser control 1104 for interaction via the UI 1106. The rules engine 640 and repository can be leveraged by the user from the CDS server 1118 via the UI 1106, for example.

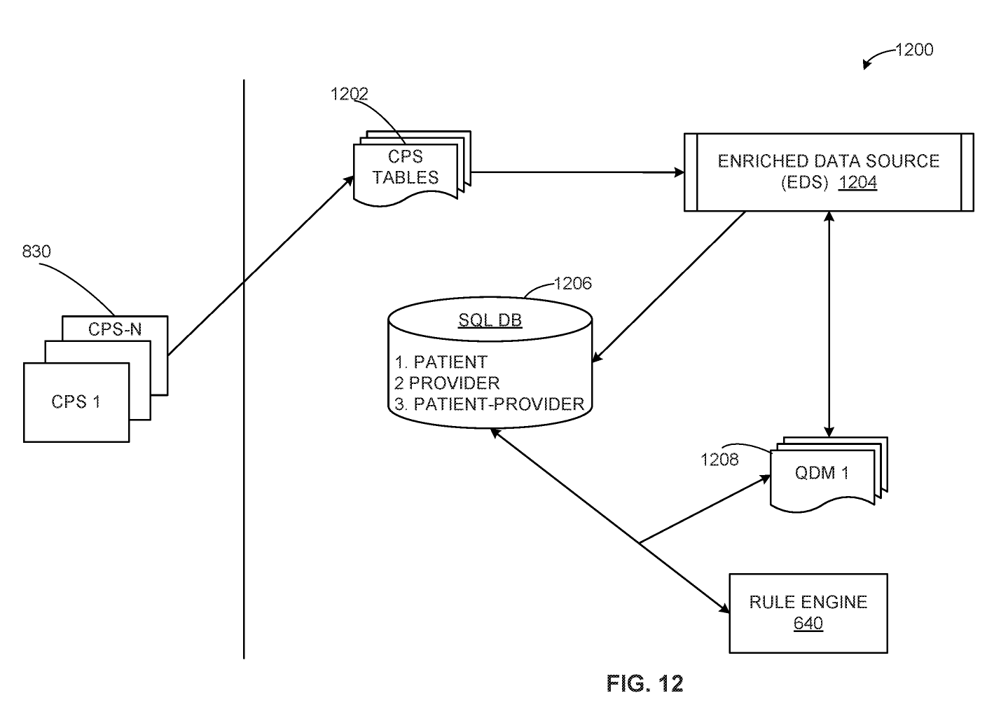

FIG. 12 provides a data flow 1200 for clinical quality reporting (CQR) using the rule engine 640. As shown in the example of FIG. 12, data is moved from one or more on-premise CPS 830 to one or more CPS tables 1202 located in the cloud via an application development framework (ADF), for example. Enriched data is created with standard codes and provided from the CPS table(s) 1202 to an enriched data source (EDS) 1204. Enriched data in the EDS 1204 can be formed using term mapping and can be partitioned by patient identifier, tenant, etc. The EDS 1204 can be implemented in a data warehouse system such as a Hive data warehouse, etc., with data organized according to one or more quality data models (QDM), for example.

Enriched data can be executed from the EDS 1204 to a database 1206, such as a structured query language (SQL) database 1206 according to patient, provider, and patient-provider information (e.g., using one or more SQL tables to identify patients, etc.). Additionally, a patient longitudinal health record (LHR) can be formed from QDMs 1208 of enriched patient data from the EDS 1204. In certain examples, the database 1206 can be queried to identify patient(s), and corresponding patient data can be pulled from the QDM 1208. The rule engine 640 is invoked for each patient QDM 1208 to process patient data according to rule(s) to generate a clinical quality report, for example.

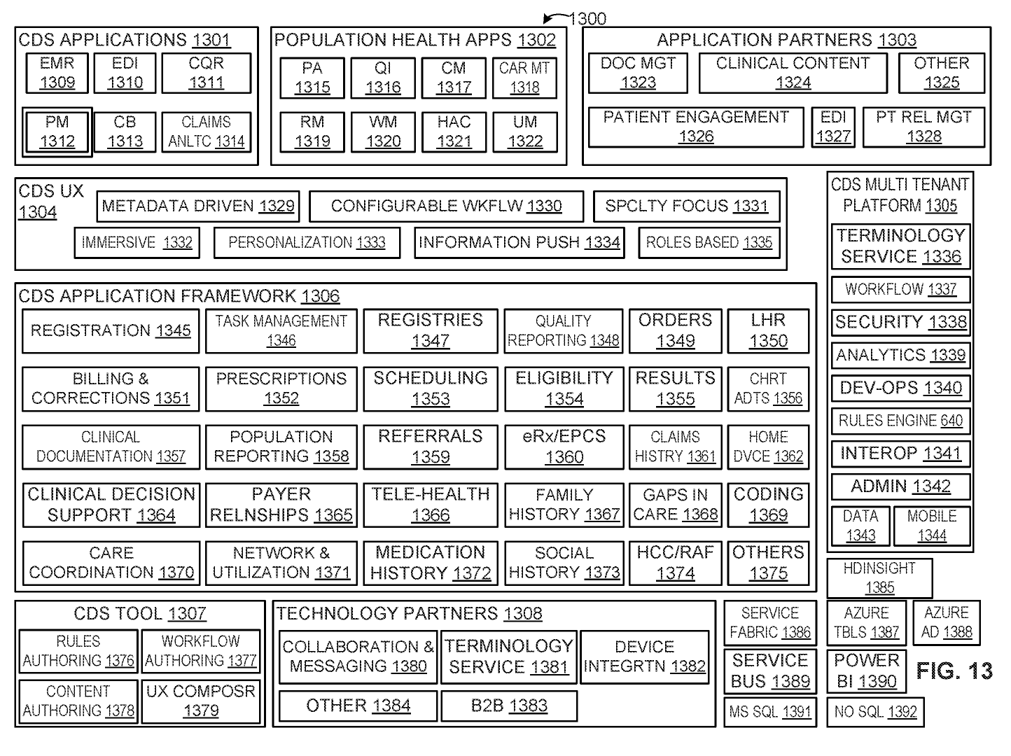

FIG. 13 illustrates an architectural block diagram of an example clinical decision support (CDS) system 1300 including the rules engine 640. The example CDS system 1300 includes CDS applications 1301, population health applications 1302, partner applications 1303, CDS user experience (UX) 1304, a CDS multi-tenant platform 1305, a CDS application framework 1306, CDS tools 1307, technology partners 1308, etc.

More particularly, as shown in the example of FIG. 13, CDS applications 1301 can include an EMR 1309, electronic data interchange (EDI) 1310, CQR 1311, practice management (PM) 1312, clinical business (CB) 1313, claims analytics (e.g., GE Denials-IQ™, etc.) etc. Population health applications 1302 can include patient-provider assignment (PA) 1315, quality improvement (QI) 1316, care management (CM) 1317, care management 1318, risk management (RM) 1319, patient wellness management (WM) 1320, hospital acquired condition (HAC) 1321, utilization management (UM) 1322. Other partner applications 1303 can include document management 1323, clinical content 1324, other content 1325, patient engagement 1326, EDI 1327, patient relationship management 1328, etc.

Additionally, as shown in the example of FIG. 13, CDS UX 1304 components can include a metadata driven UX component 1329, a configurable workflow 1330, a specialty focus UX component 1331, an immersive UX component 1332, a personalization component 1333, an information push component 1334, a role-based UX component 1335, etc. The example CDS multi-tenant platform 1305 can include a terminology service 1336, a workflow engine 1337, a security component 1338, analytics 1339, a development and operations (dev-ops) component 1340, the rules engine 640, an interoperability component 1341, an administrator 1342, a data component 1343, a mobile component 1344, etc.

In the example of FIG. 13, the CDS application framework 1306 can include registration 1345, task management 1346, registries 1347, quality reporting (QR) 1348, orders 1349, longitudinal health record (LHR) 1350, billing and corrections 1351, prescriptions 1352, scheduling 1353, eligibility 1354, results 1355, chart audits 1356, clinical documentation 1357, population reporting 1358, referrals 1359, electronic prescriptions (eRx)/electronic prescriptions for controlled substances (EPCS) 1360, claims history 1361, home device 1362, clinical decision support (CDS) 1364, payer relationships 1365, tele-health 1366, family history 1367, gaps in care 1368, coding 1369, care coordination 1370, network and utilization 1371, medication history 1372, social history 1373, hierarchical condition category (HCC)/risk adjustment factor (RAF) 1374, other 1375.

In the example of FIG. 13, the CDS tools 1307 can include a rules authoring tool 1376, a workflow authoring tool 1377, a content authoring tool 1378, a UX composer tool 1379, etc. Technology partners 1308 can include collaboration and messaging 1380, a terminology service 1381, device integration 1382, business-to-business (B2B) transaction component 1383, and/or other component 1384, for example. Other components in the example system 1300 include a service fabric 1386, cloud (e.g., Microsoft Azure™, etc.) tables 1387, cloud active directory 1388, a service bus 1589, business analytics (e.g., Microsoft Power BI, etc.) 1390, data server (e.g., Microsoft SQL server, etc.) 1391, non-relational database 1392 (e.g., NoSQL, etc.), etc. Thus, the rules engine 640 can be used with a variety of applications 1301, 1302, 1303, 1306, 1308 as well as authoring tools 1307 and user interface components 1304 to provide rules-based application services to a user.

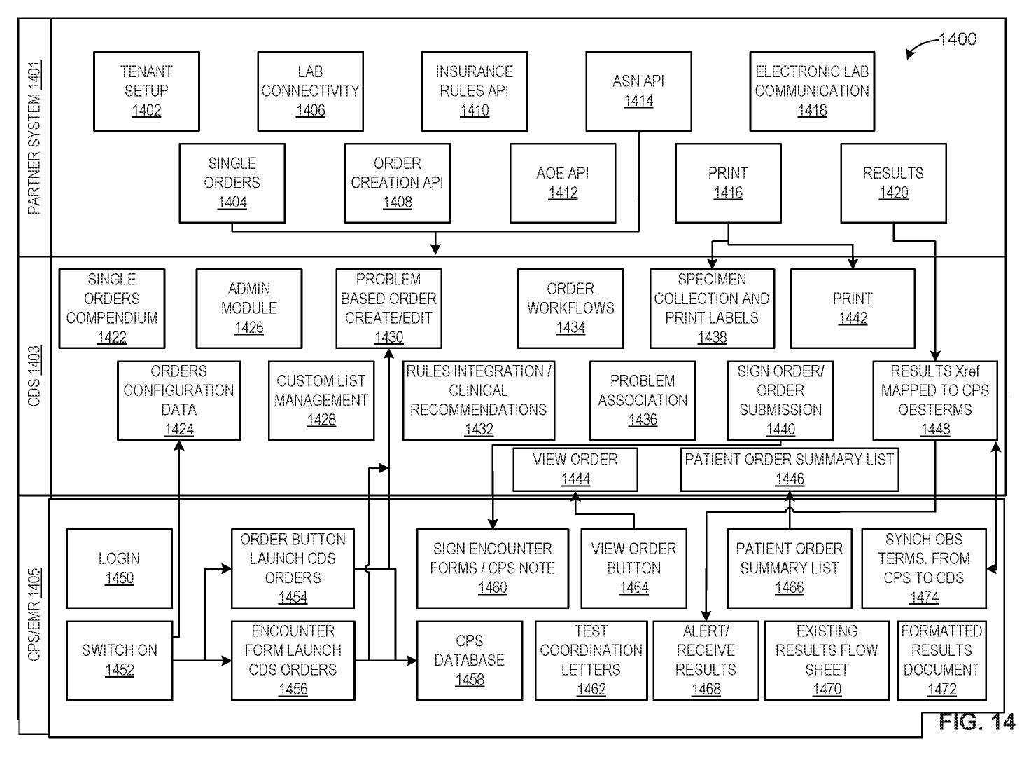

FIG. 14 illustrates another example block diagram of a system 1400 integrating a partner system 1401 with a CDS 1403 and CPS/EMR 1405. As shown in the example of FIG. 14, the partner system 1401 can provide one or more API, communication, etc., to interface with the CDS 1403 which interfaces with the CPS/EMR 1405 to leverage stored clinical information and rules to deliver application functionality to a user.

As shown in the example of FIG. 14, partner system 1401 components such as tenant setup 1402, single orders 1404, lab connectivity 1406, order creation API 1408, insurance rules API 1410, Ask at Order Entry (AOE) API 1412, abstract syntax notation (ASN) API 1414, print component 1416, electronic lab communication 1418, results 1420, etc. Order(s) 1404 can be provided to the CDS 1403 for rules-based processing.

For example, the CDS 1403 provides a single orders compendium 1422 to receive the single order 1404. Order configuration data 1424 provides order configuration information to the administrative module 1426 and custom list management 1428. The CDS 1403 provide problem-based order creation and/or editing 1430 as well as rules integration/clinical recommendation 1432. The rules integration/clinical recommendation component 1432 can include the rules engine 640 and its associated repository, terminology services, etc., for example. The CDS 1403 also provide order workflows 1434 and problem association 1436. The CDS 1403 includes specimen collection and print labels 1438 and print component 1442 to interact with the print component 1416 of the partner system 1400. An order signature/order submission component 1440 interacts with the CPS/EMR 1405 to submit an order. The order can be viewed 1444 and a patient order summary list 1446 can be provided. The results 1420 from the partner system 1401 are cross-referenced and mapping to observation terms at the CPS/EMR 1405 via the mapper 1448 of the CDS 1403.

As shown in the example of FIG. 14, the CPS/EMR 1405 provides a login 1450 and switch on or activator 1452 to access order configuration data 1424 from the CDS 1403 and/or launch CDS orders via an order button 1454 and/or encounter form 1456. Order(s) are provided to a CPS database 1458. The sign order/order submission 1440 at the CDS 1403 communicates with an encounter form/note sign component 1460 at the CPS/EMR 1405. Test coordination letter(s) 1462 can be generated by the CPS/EMR 1405. The CPS/EMR 1405 can provide a view order button 1464 for a user to view order(s) 1444 stored at the CDS 1403. A patient order summary list 1466 can be provided by the CPS/EMR 1405 to the patient order summary list 1446 of the CDS 1403. The CPS/EMR 1405 can communicate with the mapper 1448 of the CDS 1403 to generate an alert/receive results 1468, for example. Results can be used to generate a flow sheet 1470. The flowsheet 1470 can be used to generate a formatted results document 1472. Observation terms can be synchronized 1474 between the mapper 1448 at the CDS 1403 and the CPS/EMR 1405.

Thus, certain examples provide systems and methods in which workflow rules drive automation for electronic medical records and other systems through tasking, alerts, suggestions, etc. Certain examples facilitate completion of various portions of medical practice activities (e.g., management, registration, rooming, encounter, visit summary, billing, etc.) through facilitation of the workflow to eliminate manual processes. Certain examples provide a role-based rules system to determine access, tasks, alerts and suggestions to be presented to complete medical practice activities. In certain examples, the system also allows for both role-based rules and individual custom rules to be created. Certain examples drive web page and/or other interface content navigation to complete tasks.

Using the rules engine 640, for example, provider input and/or one or more triggers can activate the rules engine 640 to apply productive analytics. An example of such analytics is as follows: Suppose a patient is over the age of 13; the rules engine 640 can advise a provider to inquire whether the patient smokes. Such alerting and proactive suggestion for provider-patient encounter interaction, diagnosis, and/or treatment can be extrapolated into more complex conditions such as cancers and/or other inherited conditions. For example, if the patient has a documented family history, the rules engine 640 can advise the provider to inquire further and advise productive procedures such as a mammogram for breast cancer. Analytics, such as meaningful use (MU), clinic-specific, custom, etc., can be built, executed, and maintained in conjunction with the rules engine 640 to provide clinical decision support.

Providers have a limited amount of time and cognitive energy. By providing a solution that decreases the amount of cognitive load and time required for initial and mundane diagnostics, providers can instead exert their cognitive energy on more complex conditions. Additionally, patient outcome can be improved by intervening earlier in the patient care cycle. Certain examples enable a provider to provide benchmark goals to the patient to prevent worsening of a condition and improve overall health while decreasing medical cost over the patient's life time.

Certain examples, increase medical evidence if a patient does not comply with preventive measures. Insurance claims can become more accurate due to greater and more complete sets of monitored information.

In certain examples, machine learning technologies (e.g., convolutional neural network, deep learning network, feature-based machine learning, etc.) can be applied to unlabeled patient data in one or more specified subject areas such as smoking, drinking, etc. The system can apply the machine learning to determine points of intervention between the provider and his or her patient.

In operation, in certain examples, the rules engine 640 executes against patient facts and type of appointment scheduled. The clinical decision support system packages results as tasks, activities and/or order recommendations to end users for next steps in patient care (e.g., in a patient care plan or pathway, etc.).

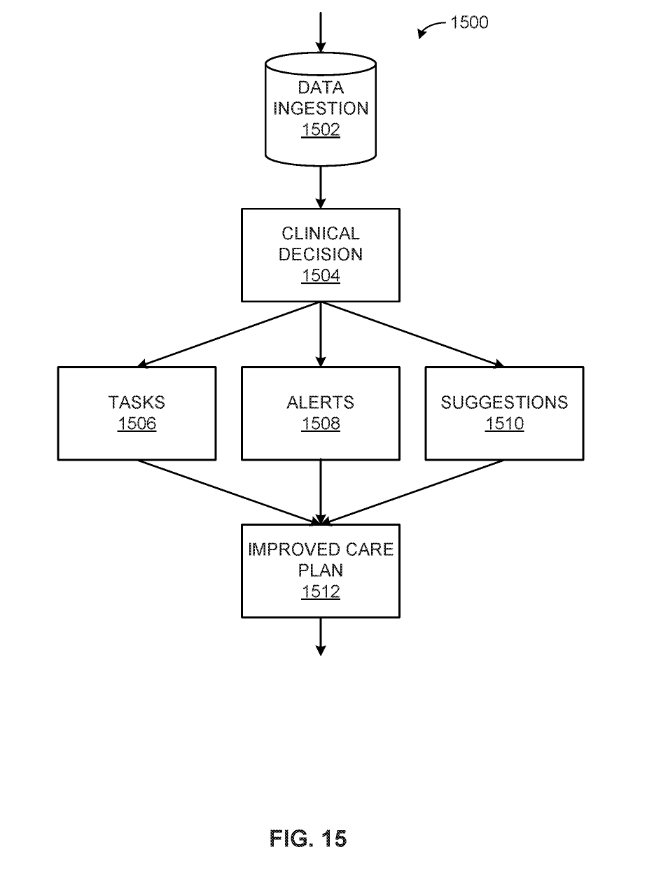

Thus, as shown in the example of FIG. 15, a clinical decision support system 1500 can leverage the rules engine 640 as part of the clinical decision support to generate an improved patient outcome. As shown in the example of FIG. 15, data ingestion 1502 receives and processes (e.g., formats, normalizes, validates, etc.) incoming data such as patient data, purpose/reason for examination, lab results, etc. Clinical decision support 1504 (e.g., including the rules engine 640, EMR, scheduling/billing system, etc.) processes the ingested data based on one or more rules, repository information, etc., to generate one or more tasks 1506, alerts 1508, and/or other suggestions 1510 for the patient. The tasks(s) 1506, alert(s) 1508, and/or suggestion(s) 1510 are used to generate an improved care plan 1512 for the patient.

In certain examples, clinical decision support 1504 can involve adjustment of a rule and/or creation of a new rule via the rules engine 640 and repository based on the ingested information for the patient. Monitoring of incoming clinical data (e.g., from patient appointments, lab results, and/or other input data, etc.) can be used with respect to the rule(s) to determine whether the patient care plan 1512 is being followed to complete a specified task 1506, for example. If the task 1506 is not being accomplished according to the care plan 1512, an alert 1508 can be generated and/or a suggestion 1510 can be provided to the patient, provider and/or to adjust the task 1506 and/or overall care plan 1512 based on the alert 1508 and/or suggestion 1510, for example.

Thus, certain examples enable ingestion of information and evaluation of rule(s) to generate, monitor, prompt, and adjust a patient care plan. Certain examples facilitate monitoring of patient data and comparison to evaluate compliance with the care plan and satisfaction of a goal for the patient. In certain examples, the care plan and/or goal are modified if the goal is not being attained and/or the care plan is not being followed.

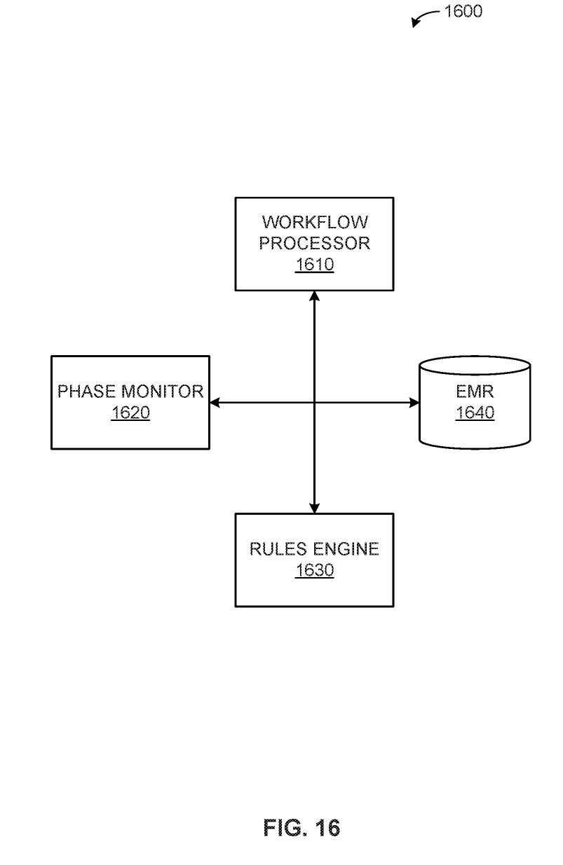

FIG. 16 illustrates an example system 1600 implementing the rules engine 640 and clinical decision support 1403 in the form of a workflow processor 1610, a phase monitor 1620, a rules engine 1630, and an EMR 1640. For example, the CDS 1403 can be used to form the workflow processor 1610 and/or the phase monitor 1620, the rules engine 640 can be used to form the rules engine 1630, and the EMR/CPS 1405 can be used to form the EMR 1640.

In an example, the rules engine 1630 and the EMR 1640, in conjunction with the workflow processor 1610, generate a workflow to treat a particular patient according to information regarding that patient (e.g., patient exam records, diagnosis of condition, rules and/or other protocol information regarding the condition, etc.). The example workflow processor 1610, rules engine 1630, and EMR 1640 identify roles relevant to the workflow in the healthcare environment. The workflow processor 1610 divides the workflow into phases. Each phase includes at least one activity specified by rule(s) from the rules engine 1630. Each activity involves at least one role and at least one associated task, alert, and/or suggestion for the at least one role specified by the rule(s). The workflow processor 1610 associates each phase with its rule(s) and role(s). The rules from the rules engine 1630 connect the activities of the phases of the workflow to the EMR 1640 automatically provide and/or receive data for the patient in each phase of the workflow.

The example workflow processor 1610 facilitates execution of the workflow with respect to the patient. For example, the workflow processor 1610 facilitates interaction between healthcare systems, the patient, and/or a healthcare provider to executes the workflow associated with care of the patient (e.g., a patient care plan, care path, treatment protocol, etc.). The example phase monitor 1620 monitors execution of the workflow to determine which phase of the workflow is executing. The rules engine 1630 can then work with the phase monitor 1620 and the workflow processor 1610 to determine successful and/or unsuccessful execution of activities or tasks in the workflow phase. An identified deviation from the workflow phase can result in an alert (e.g., to the patients, the provider, and/or healthcare system(s), etc.), a suggestion, a task adjustment, etc. Execution of the workflow and its phases can be monitored and adjusted dynamically in real time (or substantially real time given information transmission and/or processing delay) using the phase monitor 1620 and the workflow processor 1610 in conjunction with rules from the rules engine 1630 and data from the EMR 1640.

Thus, the workflow processor 1610, rules engine 1630, and EMR 1640 identify the patient, identify the workflow for patient care, identify personnel and resources (e.g., assets) to care for the patient through the workflow, divide workflow into phases based on activity and role, monitor execution of phases, and provide information to/from assets to drive the workflow for care of the patient.

Certain examples facilitate creation of role-based rules and/or custom rules using the rules engine 1630, EMR 1640 and/or feedback gathered from the workflow processor 1610 and/or phase monitor 1620. Certain examples provide a cloud-based platform leveraged through interaction with system APIs to support roles and functions for workflow(s). In certain examples, in addition to patient diagnosis and/or treatment activities, medical practice activities. Medical practice activities can include management, registration, rooming, encounter, visit summary, billing. Certain examples provide an integrated solution including database(s), information technology infrastructure, user interface, task management, front end operation, etc. In certain examples, a journey map can be formed for a patient and/or provider including roles (e.g., provider role(s), other persona(s), etc.), resources (e.g., assets and/or other components, services, etc.), activities/tasks, and associated rules for each phase of the healthcare workflow. In certain examples, rules can be changed dynamically on the cloud-based server side, but roles and phases remain unchanged on the user end in the healthcare environment.

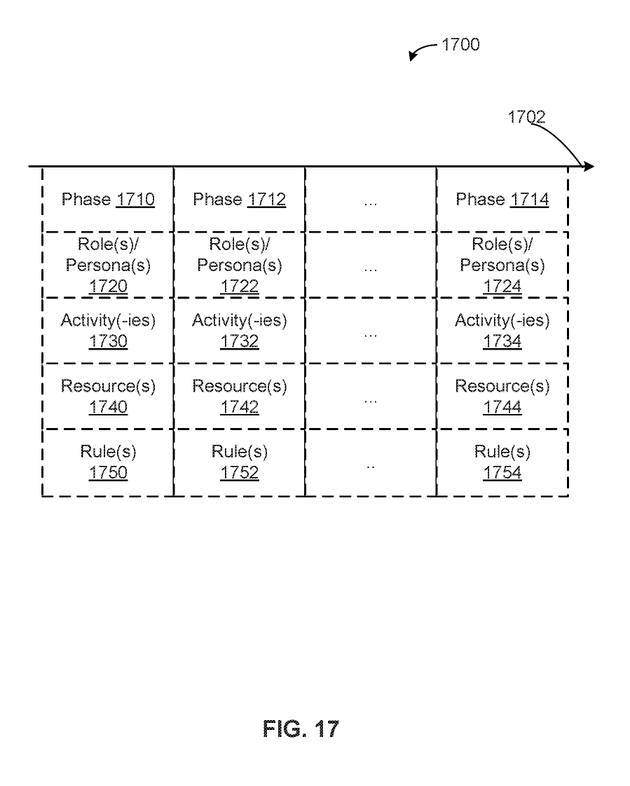

FIG. 17 illustrates a visualization of a journey map 1700 for a healthcare workflow 1702 for a patient. The patient workflow or journey 1702 is divided into phases 1710-1714. Within each phase 1710-1714, one or more roles/personas 1720-1724 are allocated to the respective phase 1710-1714. Thus, the map 1700 of the workflow 1702 provides an indication of who is to be involved in each phase 1710-1714 based on the included role(s) 1720-1724.

Further, each phase 1710-1714 includes an indication of activity(-ies) 1730-1734 involved in the respective phase 1710-1714. Thus, for each phase 1710-1714, the map 1700 informs which role(s) 1720-1724 are to perform which task(s) 1730-1734 in that phase 1710-1714. Additionally, the map 1700 identifies resource(s) 1740-1744 used in the activity(-ies) 1730-1734 for the role(s) 1720-1724 in each phase 1710-1714. The journey map 1700 also includes an indication of rule(s) 1750-1754 governing the activity(-ies) 1730-1734 and/or associated role(s) 1720-1724 and/or resource(s) 1740-1744 involved in each phase 1710-1714.

Thus, the example journey map 1700 for the workflow 1702 can be used to drive the workflow 1702 such that the workflow processor 1610, phase monitor 1620, rules engine 1630, EMR 1640 and associated role(s) 1720-1724 understand where, when, and how the phases 1710-1714 of the workflow 1702 should be executed.

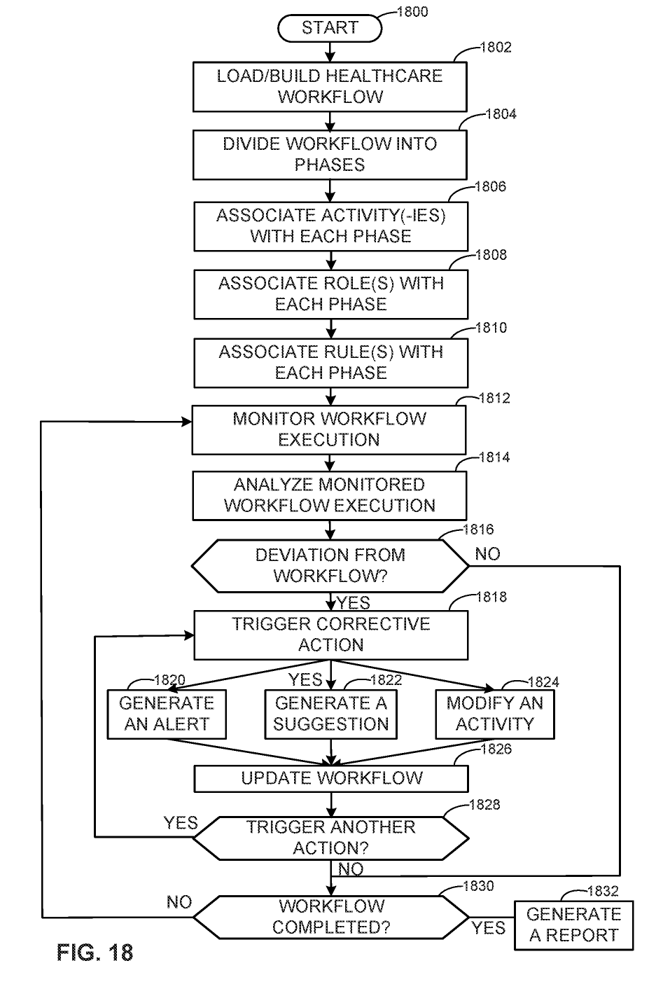

FIG. 18 illustrates a flow diagram of an example method 1800 of patient care plan composition, monitoring, and adjustment using the example workflow processor 1610, phase monitor 1620, rules engine 1630, and EMR 1640. At block 1802, a healthcare workflow is loaded and/or built for processing in preparation of execution. For example, the rules engine 1630 and the EMR 1640, in conjunction with the workflow processor 1610, load and/or build a workflow to treat a particular patient according to information regarding that patient (e.g., patient exam records, diagnosis of condition, rules and/or other protocol information regarding the condition, etc.).

Then, the workflow is processed. At block 1804, the workflow is divided into phases. The workflow processor 1610 divides the workflow into phases, segments, or portions representing discrete parts of the healthcare workflow to be executed with respect to the patient. At block 1806, one or more activities/tasks are associated with each phase of the workflow. For example, each phase includes at least one activity (e.g., registration, pre-exam, exam, post-exam, follow-up, pre-op, operation, post-op, etc.) specified by the workflow. The workflow processor 1610 identifies and associates activity(-ies) with each phase of the workflow.

At block 1808, one or more roles (e.g., patient, receptionist, nurse, primary physician, radiologist, surgeon, imaging technician, billing clerk, other persona, etc.) are associated with each phase of the workflow. The workflow processor 1610 associates each phase with its role(s). At block 1810, one or more rules are associated with each phase of the workflow. Each activity involves at least one role and at least one associated task, alert, and/or suggestion for the at least one role specified by the rule(s). The workflow processor 1610 associates each phase with its rule(s) and role(s). The rules from the rules engine 1630 connect the activities of the phases of the workflow to the EMR 1640 automatically provide and/or receive data for the patient in each phase of the workflow. Thus, the example workflow processor 1610, rules engine 1630, and EMR 1640 identify activities, roles, and rules relevant to the workflow in the healthcare environment and instantiates them with respect to each phase.

At block 1812, execution of the workflow by the workflow processor 1610, rules engine 1630, and EMR 1640 is monitored by the phase monitor 1620. The example the workflow processor 1610 facilitates execution of the workflow with respect to the patient. For example, the workflow processor 1610 facilitates interaction between healthcare systems, the patient, and/or a healthcare provider to executes the workflow associated with care of the patient (e.g., a patient care plan, care path, treatment protocol, etc.). The example phase monitor 1620 monitors execution of the workflow to determine which phase of the workflow is executing and how.

At block 1814, monitored execution of the workflow is analyzed by the phase monitor 1620 to determine a deviation from the workflow. For example, the rules engine 1630 can work with the phase monitor 1620 and the workflow processor 1610 to determine successful and/or unsuccessful execution of activities or tasks in the workflow phase. At block 1816, a deviation from the workflow is determined. If a deviation is identified, then, at block 1818, one or more corrective actions are triggered.

For example, an identified deviation from the workflow phase can result in an alert (e.g., to the patients, the provider, and/or healthcare system(s), etc.), a suggestion, a task adjustment, etc. At block 1820, an alert is generated in response to the deviation from the workflow. For example, an audible and/or visible alert is generated for the provider, the patient, etc. In certain examples, an electronic alert can be logged, routed to another program, etc. At block 1822, a suggestion of action is generated in response to the deviation from the workflow. For example, a tip, suggestion, reminder, etc., can be generated for the patient and/or provider to help comply with the workflow (e.g., exercise, reposition, register, fast, add more contrast, etc.). At block 1824, an activity in the phase of the workflow is modified. For example, an amount of exercise, a period of fasting before labs are taken, a dosage of medication, a time for surgery, etc., can be modified to adjust for the deviation from the expected workflow. In certain examples, a change in care plan and the associated workflow can occur through a change in medication, an ordering of a new/different exam, a request for additional labs, an instruction for different eating habits and/or exercise, etc.

At block 1826, the workflow is updated based on the triggered action. At block 1828, if more than one corrective action was indicated, then control returns to block 1818 to trigger an additional corrective action. If no further corrective action is indicated, then, at block 1830, the workflow is examined to determine if the workflow has been completed. If the workflow has not been completed, then control returns to block 1812 to monitor execution of the workflow. If the workflow has been completed, then, at block 1832, a report is generated to capture the patient and/or provider's journey through the workflow and its execution. Thus, execution of the workflow and its phases can be monitored and adjusted dynamically in real time (or substantially real time given information transmission and/or processing delay) using the phase monitor 1620 and the workflow processor 1610 in conjunction with rules from the rules engine 1630 and data from the EMR 1640.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

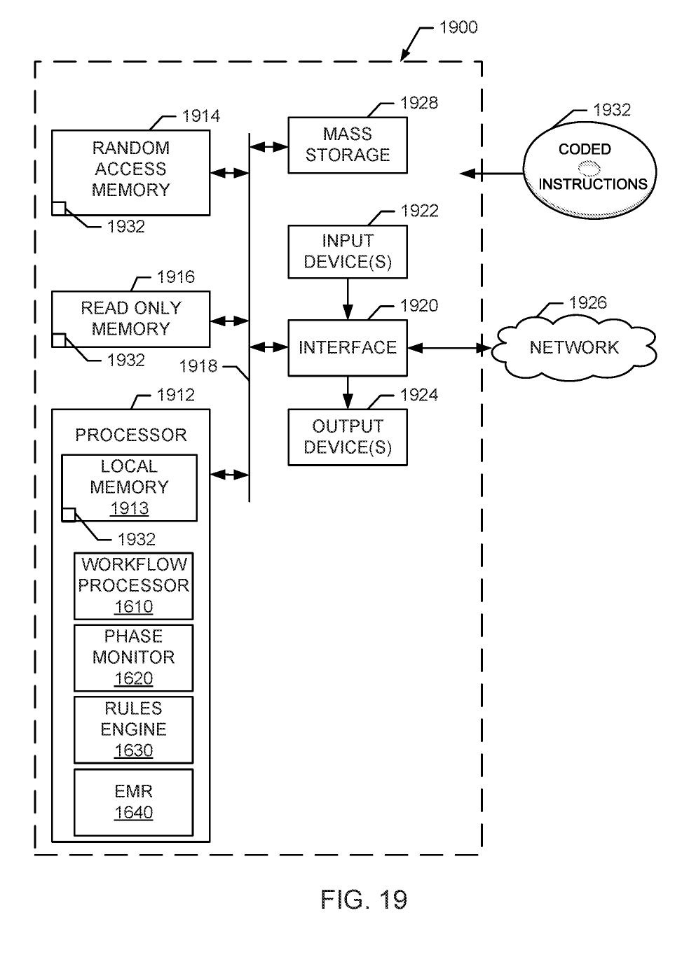

FIG. 19 is a block diagram of an example processor platform 1900 capable of executing instructions to implement the example systems and methods of FIGS. 1-18. The processor platform 1900 can be, for example, a server, a personal computer, a mobile device (e.g., a cell phone, a smart phone, a tablet such as an IPAD™), a personal digital assistant (PDA), an Internet appliance, or any other type of computing device.

The processor platform 1900 of the illustrated example includes a processor 1912. Processor 1912 of the illustrated example is hardware. For example, processor 1912 can be implemented by one or more integrated circuits, logic circuits, microprocessors or controllers from any desired family or manufacturer.

Processor 1912 of the illustrated example includes a local memory 1913 (e.g., a cache). Processor 1912 of the illustrated example is in communication with a main memory including a volatile memory 1914 and a non-volatile memory 1916 via a bus 1918. Volatile memory 1914 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1916 can be implemented by flash memory and/or any other desired type of memory device. Access to main memory 1914, 1916 is controlled by a memory controller. The processor 1912, alone or in conjunction with the memory 1913, can be used to implement the workflow processor 1610, the phase monitor 1620, the rules engine 1630, the EMR 1640, and/or other part of the systems disclosed herein.

Processor platform 1900 of the illustrated example also includes an interface circuit 1920. Interface circuit 1920 can be implemented by any type of interface standard, such as an Ethernet interface, a universal serial bus (USB), and/or a PCI express interface.

In the illustrated example, one or more input devices 1922 are connected to the interface circuit 1920. Input device(s) 1922 permit(s) a user to enter data and commands into processor 1912. The input device(s) 1922 can be implemented by, for example, an audio sensor, a microphone, a camera (still or video), a keyboard, a button, a mouse, a touchscreen, a track-pad, a trackball, isopoint and/or a voice recognition system.

One or more output devices 1924 are also connected to interface circuit 1920 of the illustrated example. Output devices 1924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 1920 of the illustrated example, thus, typically includes a graphics driver card, a graphics driver chip or a graphics driver processor.

Interface circuit 1920 of the illustrated example also includes a communication device such as a transmitter, a receiver, a transceiver, a modem and/or network interface card to facilitate exchange of data with external machines (e.g., computing devices of any kind) via a network 1926 (e.g., an Ethernet connection, a digital subscriber line (DSL), a telephone line, coaxial cable, a cellular telephone system, etc.).

Processor platform 1900 of the illustrated example also includes one or more mass storage devices 1928 for storing software and/or data. Examples of such mass storage devices 1928 include floppy disk drives, hard drive disks, compact disk drives, Blu-ray disk drives, RAID systems, and digital versatile disk (DVD) drives.

Coded instructions 1932 associated with any of FIGS. 1-20 can be stored in mass storage device 1928, in volatile memory 1914, in the non-volatile memory 1916, and/or on a removable tangible computer readable storage medium such as a CD or DVD.

It may be noted that operations performed by the processor platform 1900 (e.g., operations corresponding to process flows or methods discussed herein, or aspects thereof) may be sufficiently complex that the operations may not be performed by a human being within a reasonable time period.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus comprising:
a rules engine including rules for workflow execution;
a workflow processor to identify a patient and determine a workflow for care of the patient, the workflow processor to divide a workflow into phases, each phase associating rules from the rules engine with at least one role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow; and
a phase monitor to monitor execution of the phases of the workflow, the phase monitor to trigger at least one of the associated task, alert or suggestion to drive the workflow for care of the patient.

2. The apparatus of claim 1, wherein the phases of the workflow and associated activities and data form a journey map to guide at least one of a patient, a healthcare provider, or a healthcare system through the workflow.

3. The apparatus of claim 2, wherein the journey map provides an integrated solution including data, infrastructure, task management, and user interface.

4. The apparatus of claim 1, wherein the rules engine is to facilitate creation of at least one of role-based rules or custom rules for the workflow.

5. The apparatus of claim 1, wherein at least one of the associated task, alert or suggestion is triggered in response to a determined deviation from the workflow.

6. The apparatus of claim 1, wherein the apparatus is hosted in a cloud-based platform leveraged through an application programming interface.

7. The apparatus of claim 6, wherein the rules are to be changed dynamically via the cloud-based platform and wherein the roles and phases are to remain unchanged in a user environment.

8. A computer-implemented method comprising:
identifying, using a processor, a patient;
determining, using the processor, a workflow for care of the patient;
identifying, using the processor, roles and rules in the workflow;
dividing a workflow into phases, each phase associating rules with each role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow;
monitoring execution of the phases of the workflow; and
triggering at least one of the associated task, alert or suggestion to drive the workflow for care of the patient.

9. The method of claim 8, wherein the phases of the workflow and associated activities and data form a journey map to guide at least one of a patient, a healthcare provider, or a healthcare system through the workflow.

10. The method of claim 9, wherein the journey map provides an integrated solution including data, infrastructure, task management, and user interface.

11. The method of claim 8, further including facilitating creation of at least one of role-based rules or custom rules for the workflow.

12. The method of claim 8, wherein at least one of the associated task, alert or suggestion is triggered in response to a determined deviation from the workflow.

13. The method of claim 8, wherein the processor is hosted in a cloud-based platform leveraged through an application programming interface.

14. The method of claim 13, wherein the rules are to be changed dynamically via the cloud-based platform and wherein the roles and phases are to remain unchanged in a user environment.

15. A tangible computer-readable storage medium including instructions which, when executed, particularly configure a processor to implement a method, the method comprising:
identifying a patient;
determining a workflow for care of the patient;
identifying roles and rules in the workflow;
dividing a workflow into phases, each phase associating rules with each role, each phase including at least one activity specified by the rules, each activity involving at least one role and at least one associated task, alert, or suggestion for the at least one role specified by the rules, wherein the rules connect the activities of the phases of the workflow to an electronic medical record system to automatically provide and receive data for a patient in each phase of the workflow;
monitoring execution of the phases of the workflow; and
triggering at least one of the associated task, alert or suggestion to drive the workflow for care of the patient.

16. The storage medium of claim 15, wherein the phases of the workflow and associated activities and data form a journey map to guide at least one of a patient, a healthcare provider, or a healthcare system through the workflow.

17. The storage medium of claim 16, wherein the journey map provides an integrated solution including data, infrastructure, task management, and user interface.

18. The storage medium of claim 15, further including facilitating creation of at least one of role-based rules or custom rules for the workflow.

19. The storage medium of claim 15, wherein at least one of the associated task, alert or suggestion is triggered in response to a determined deviation from the workflow.

20. The storage medium of claim 15, wherein the rules are to be changed dynamically via a cloud-based platform and wherein the roles and phases are to remain unchanged in a user environment.
